(19) United States
(12) Patent Application Publication
(10) Pub. No.: US 2025/0336386 A1
(43) Pub. Date: Oct. 30, 2025

(54) METHODS FOR ACOUSTIC FEEDBACK MANAGEMENT ON OPEN EAR HEARING DEVICES

(71) Applicant: Meta Platforms Technologies, LLC, Menlo Park, CA (US)

(72) Inventors: Morteza Khaleghimeybodi, Bothell, WA (US); Martin Kuriger, Fribourg (CH); Bernhard Kuenzle, Düdingen (CH); Christi Miller, Seattle, WA (US); Melinda Anderson, Lake Forest Park, WA (US); Timothy Streeter, Portland, OR (US); Andrew Lovitt, Redmond, WA (US); Andreas Thelander Bertelsen, San Francisco, CA (US); Jan Linden, San Francisco, CA (US); Nils Thomas Fritiof Lunner, Redmond, WA (US); Ravish Mehra, Seattle, WA (US); Thomas Ivan Harvey, Melbourne (AU)

(21) Appl. No.: 19/186,138

(22) Filed: Apr. 22, 2025

Related U.S. Application Data
(60) Provisional application No. 63/640,850, filed on Apr. 30, 2024.

(51) Int. Cl. G10K 11/178

(52) U.S. Cl. CPC G10K 11/17819; G10K 11/17823; G10K 11/17881; G10K 11/17825; G10K 2210/1081; G10K 2210/3026; G10K 2210/3027; G10K 2210/3055; G10K 2210/3215; G10K 2210/506

(57) ABSTRACT

Methods and systems are described for mitigating acoustic feedback via an open ear device. In various examples, systems or methods may receive, via a first microphone and a second microphone positioned on an open ear device, a first audio signal and a second audio signal, respectively. The first audio signal and second audio signal may be converted to a first digital audio signal and a second digital audio signal. The first digital audio signal and second digital audio signal may be independently processed by an AFC to reduce acoustic feedback. A beamformer may adjust the first digital audio signal and second digital audio signal based on a target direction to create a beamformer digital audio signal. The beamformer digital audio signal may be processed via feedforward processing to create a target audio. The target audio may be phase shifted and transmitted to a loudspeaker positioned on the open ear device.

### CROSS-REFERENCE TO RELATED APPLICATIONS

This application claims the benefit of U.S. Provisional Patent Application No. 63/640,850, filed Apr. 30, 2024, entitled “Methods For Acoustic Feedback Management On Open-Ear Hearing Devices,” the entire content of which is incorporated herein by reference.

### TECHNOLOGICAL FIELD

Examples of the present disclosure relate generally to methods, apparatuses, and computer program products for generative artificial intelligence for audio pathways.

### BACKGROUND

Electronic devices are constantly evolving to provide a user with flexibility and adaptability. By increasing adaptability in electronic devices, users are keeping their devices on them during daily activities. In many instances, it may be imperative for a user to be able to hear what is being conveyed on their electronic device. Methods or systems generally are in place to aid in the user's ability to hear to enable effortless communication in noisy environments for users.

### BRIEF SUMMARY

Methods and systems are described for acoustic feedback cancellation via algorithms and/or applications associated with an open ear audio device (e.g., smart glasses, headphones, head mounted displays, hearing-aids, or any device that may provide sound without covering or blocking the ear completely).

In various examples, systems and methods may receive, via a first microphone and a second microphone positioned on an open ear device, a first audio signal and a second audio signal. The first and second audio signals may be converted to a first digital audio signal and a second digital audio signal. The system may utilize an adaptive feedback canceller (AFC) to reduce the acoustic feedback, wherein the AFC may independently process the first and second digital audio signals. A beamformer may be utilized to adjust, based on a target direction, the first and second digital audio signals independently processed by the AFC to create a beamformer digital audio signal. The beamformer digital audio signal may be processed via feedforward processing to create a target audio signal. The target audio signal may be split creating two signals with the same audio content. The target audio signals may be received by a phase shifter, where one target audio signal may be phase shifted or inverted. The phase shifted target audio signals may be transmitted based on the target direction to a loudspeaker positioned on the open ear device.

In various examples, systems and methods may receive, via a first microphone and a second microphone positioned on an open ear device, a first audio signal and a second audio signal. The first microphone may be positioned at a first position on a first side associated with the open ear device, and the second microphone may be positioned at a second position on a second side associated with the open ear device. The first and second audio signals may be converted to a first digital audio signal and a second digital audio signal. The system may utilize an AFC to reduce the acoustic feedback, wherein the AFC may independently process the first and second digital audio signals to estimate transfer functions. The estimated transfer functions may be utilized to mitigate acoustic feedback. The first and second digital audio signals independently processed by the AFC may be subsequently received and/or processed via a beamformer and/or feedforward processing architecture. Thereafter, the digital audio signals may undergo phase shifting to create a target audio signal(s). For example, a first target audio signal positioned at a first position may be phase shifted differently than a second target audio signal positioned at a second position. The phase shifter may be time-varying such that the phase associated with the first digital audio signal and the second digital audio signal may continuously shift phase with time. Ultimately, the phase shifted first and second digital audio signals, known as target audio signal(s), may be transmitted based on the target direction to a loudspeaker positioned on the open ear device.

In various examples, systems may comprise a loudspeaker, a first microphone, a second microphone, and a third microphone. The loudspeaker may be positioned on an open ear device, where the first microphone is a first distance from the loudspeaker, the second microphone is a second distance from the loudspeaker, and the third microphone is a third distance from the loudspeaker. The system may include a processor and a memory operably coupled to the processor, the memory including executable instructions which when executed by the processor cause the device to: receive, via the first microphone, the second microphone, and the third microphone, a first audio signal, a second audio signal, and a third audio signal, respectively; convert the first audio signal, second audio signal, and third audio signal to a first digital audio signal, a second digital audio signal, and a third digital audio signal, respectively; independently processing, via an adaptive feedback canceller (AFC), the first digital audio signal and the second digital audio signal to reduce acoustic feedback; performing, via a phase shifter, a fixed phase shift of the first digital audio signal and the second digital audio signal; adjusting, via feedforward processing, the phase shifted first and second digital audio signals to create a target audio signal; and transmit the target audio signal to a loudspeaker.

In various examples, systems or methods may receive, via an open ear device associated with a user, an audio signal associated with one or more microphones, wherein the audio signal may comprise acoustic feedback and an input signal. The audio signal may be converted to a digital audio signal, wherein the digital audio signal may be transmitted to one or more adaptive feedback cancellers (AFC). An algorithm associated with the AFC may estimate one or more transfer functions, wherein the one or more transfer functions estimated may define an acoustic feedback associated with the digital audio signal transmitted. In some examples, the algorithm may determine a coefficient scaled by a value to produce maximum forward gain. The system may filter the digital audio signal based on a combination of the one or more transfer functions estimated to produce a target audio. Feedforward processes may be utilized to process the digital audio signal to create a target audio signal. The target audio signal may be transmitted to a loudspeaker positioned on the open ear device.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an example open ear device, in accordance with an example of the present disclosure.

FIG. 2A illustrates an example open ear device, in accordance with an example of the present disclosure.

FIG. 2B illustrates an example block diagram of an example data pipeline associated with cross feedback cancellation, in accordance with an example of the present disclosure.

FIG. 2C illustrates an example block diagram of an example data pipeline associated with cross feedback cancellation, in accordance with an example of the present disclosure.

FIG. 3A illustrates an example open ear device, in accordance with an example of the present disclosure.

FIG. 3B illustrates an example block diagram of an example data pipeline associated with acoustic feedback cancellation, in accordance with an example of the present disclosure.

FIG. 3C illustrates an example block diagram of an example data pipeline associated with acoustic feedback cancellation, in accordance with an example of the present disclosure.

FIG. 4 illustrates an example block diagram of adaptive feedback cancellation associated with one or more estimated transfer functions, in accordance with an example of the present disclosure.

FIG. 5 illustrates an example method, in accordance with an example of the present disclosure.

FIG. 6 illustrates an example method, in accordance with an example of the present disclosure.

FIG. 7 illustrates an example processing system, in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present disclosure will now be described more fully hereinafter with reference to the accompanying drawings, in which some, but not all examples of the disclosure are shown. Indeed, various examples of the disclosure may be embodied in many different forms and should not be construed as limited to the examples set forth herein. Like reference numerals refer to like elements throughout.

As used herein, the terms “data,” “content,” “information” and similar terms may be used interchangeably to refer to data capable of being transmitted, received, and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical, or tangible storage medium (e.g., volatile, or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, an “open ear device” may refer to an electronic device designed to allow the user to hear ambient sounds while simultaneously listening to audio content. An open ear device does not obstruct the ear canal. In some examples, an open ear device may include components that rest on or near the ear, providing stability and comfort without sealing off the ear canal.

As referred to herein, “artificial reality” may refer to a form of immersive reality that has been adjusted in some manner before presentation to a user, which may include, for example, a virtual reality, an augmented reality, a mixed reality, a hybrid reality, Metaverse reality or some combination or derivative thereof. Artificial reality content may include completely computer-generated content or computer-generated content combined with captured (e.g., real-world) content. In some instances, artificial reality may be associated with applications, products, accessories, services, or some combination thereof, that may be used to, for example, create content in an artificial reality or are otherwise used in (e.g., to perform activities in) an artificial reality.

As referred to herein, “artificial reality content” may refer to content such as video, audio, haptic feedback, or some combination thereof, any of which may be presented in a single channel or in multiple channels (such as stereo video that produces a three-dimensional (3D) effect to the viewer) to a user.

As referred to herein, a Metaverse may denote an immersive virtual/augmented reality world in which augmented reality (AR) devices may be utilized in a network (e.g., a Metaverse network) in which there may, but need not, be one or more social connections among users in the network. The Metaverse network may be associated with three-dimensional (3D) virtual worlds, online games (e.g., video games), one or more content items such as, for example, non-fungible tokens (NFTs) and in which the content items may, for example, be purchased with digital currencies (e.g., cryptocurrencies) and other suitable currencies.

It is to be understood that the methods and systems described herein are not limited to specific methods, specific components, or to particular implementations. It is also to be understood that the terminology used herein is for the purpose of describing particular examples only and is not intended to be limiting.

In many hearing systems, such as electronic devices, hearing aids, or the like, hearing features may combine digital audio signal obtained using a number of microphones configured to produce a corrected or enhanced audio signal where the audio signal associated with the target speaker (e.g., speaker) is enhanced while the noise is attenuated. Many of these systems may amplify the signal or sound above a hearing threshold to make the sound audible to the individual (e.g., the user). In such systems, the audio signal may be presented in real-time to the user through an audio playback subsystem which amplifies the audio signal so that it is audible to the user. However, current methodologies may be insufficient or inconsistent for mitigating acoustic feedback associated with open ear devices. Additionally, in some examples, due to the proximity between a microphone and loudspeaker in size-constrained form factors, the system may be sensitive to acoustic feedback problems. In other words, the amplified signal from the loudspeaker is captured by a microphone (i.e., sensing microphone). As a result, the maximum amplification (e.g., maximum stable gain (MSG)) of the signal may be limited in hearing devices. It has been shown that for hearing amplification systems (e.g., hearing devices), the positive loop gain that is utilized to enhance the audio signal may lead to the response of the loop to diverge, and ultimately leading to acoustic feedback being received. Many hearing devices may experience acoustic feedback problems where an amplification of the audio signal may be required. The effect of acoustic feedback is apparent in open ear hearing devices, such as smart glasses, hearing aids, or the like.

In view of the foregoing, it may be beneficial to provide adaptive feedback suppression techniques to efficiently and effectively minimize acoustic feedback in the audio pipeline of open ear devices and to improve maximum stable gain (MSG). This may also lead to better sound quality and improved user experience.

The present disclosure is generally directed to systems and methods of acoustic feedback cancellation through via applications and/or algorithms associated with an open ear audio device (e.g., smart glasses, headphones, head mounted displays, or any device that may provide sound without covering or blocking the ear completely). A coustic feedback cancellation, as disclosed, may refer to minimizing or cancelling the acoustic feedback in an audio pipeline of open ear devices to improve maximum stable gain (MSG) to amplify the audio signal associated with a received sound.

In an example to achieve acoustic feedback cancellation, as disclosed, a system may utilize a distance between a first microphone and a second microphone to determine an acoustic feedback associated with an audio signal, wherein the captured acoustic feedback associated with the audio signal at a first microphone positioned a known distance from a loudspeaker may be utilized to mitigate acoustic feedback associated with the audio signal received. The audio signal may be converted to digital audio signal by an analog-to-digital converter (ADC). The digital audio signal may be received by one or more beamformers, where the one or more beamformers may perform one or more of directionally focusing the digital audio signal received, reduce noise (e.g., background noise, interference, or the like), enhance the digital audio signal, or any combination thereof, to focus the digital audio signal to a specific direction while minimizing noise from other directions. The digital audio signal from the beamformer may be received by one or more adaptive feedback cancellers (AFCs), where the one or more AFCs may be configured to perform one or more of feedback detection, adaptive filtering, signal subtraction, or the like, or any combination thereof, to remove acoustic feedback associated with the digital audio signal received. The digital audio signal received without acoustic feedback may be processed, via feed-forward processing, to produce a target audio signal.

In an example to achieve acoustic feedback cancellation, as disclosed, a system may utilize a distance between a first microphone and a second microphone to determine an acoustic feedback associated with an audio signal, wherein the captured acoustic feedback associated with the audio signal at a first microphone positioned a known distance from a loudspeaker may be utilized to mitigate acoustic feedback associated with the audio signal received. The audio signal may be converted to digital audio signal by an ADC. The digital audio signal may be received by one or more adaptive feedback cancellers (AFCs), where the one or more AFCs may be configured to perform one or more of feedback detection, adaptive filtering, signal subtraction, or the like, or any combination thereof, to remove acoustic feedback associated with the digital audio signal received. The digital audio signal received without acoustic feedback may be processed, via feed-forward processing, to produce a target audio signal.

In an example, the audio pipeline may utilize one or more beamformers, one or more AFCs, or a phase shifter, or any combination thereof, to mitigate acoustic feedback associated with a received audio signal to produce a target audio signal. In such an example, an audio signal may be received by one or more microphones. The audio signal may be converted to digital audio signal by an ADC. The digital audio signal may then be sent to one or more beamformers, which may focus the digital audio signal associated with a particular direction while minimizing noise from other directions. In some examples, the beamformer may be a symmetric mono beamformer, where one or more audio signals received at one or more microphones may be combined to create a combined digital audio signal from the symmetric mono beamformer. In some examples, the symmetric mono beamformer may comprise a monaural (diotic) beamformer. In some other examples, the beamformer may comprise a binaural (dichotic) beamformer. In the example of dichotic beamforming, there may be different beam forming parameters for each ear (e.g., left ear and right ear) to further improve spatial awareness. In some examples, the combined digital audio signal may be doubled, via a signal splitter, where two versions of the combined digital audio signal may be created. One of the two versions of the combined digital audio signal may be phase shifted, via the phase shifter, to create an inverted bi-mono digital audio signal (e.g., one of the two combined digital audio signal is shifted 180 degrees). The bi-mono digital audio signal may be received by one or more AFCs, where the one or more AFCs may be configured to perform one or more of feedback detection, adaptive filtering, signal subtraction, or the like, or any combination thereof, to remove acoustic feedback associated with the bi-mono digital audio signal received. The resultant digital audio signal may undergo feedforward processing, to produce a target audio signal.

In an example, the audio pipeline may utilize one or more AFCs, a phase shifter, or any combination thereof, to mitigate acoustic feedback associated with a received audio signal to produce a target audio signal. In such an example, an audio signal may be received by one or more microphones. The audio signal may be converted to digital audio signal by an ADC. The digital audio signal may then be phase shifted by the phaser shifter. In some examples, the phase shifter may be a time-varying phase shifter. The phase shifted digital audio signals may be received by one or more AFCs, where the one or more AFCs may be configured to perform one or more of feedback detection, adaptive filtering, signal subtraction, or the like, or any combination thereof, to remove acoustic feedback associated with the digital audio signal received. The resultant digital audio signal may undergo feedforward processing, to produce a target audio signal.

In an example, the audio pipeline may utilize an adaptive algorithm or model to estimate transfer functions between two or more microphones and one or more loudspeakers. In an example, the audio signal may undergo feed-forward processing to adjust properties of the audio signal, such that the signal may be presented to the user. In some examples, following feed-forward processing the audio signal may be adjusted via a phase element to differentiate between the audio signal received via the two or more microphones.

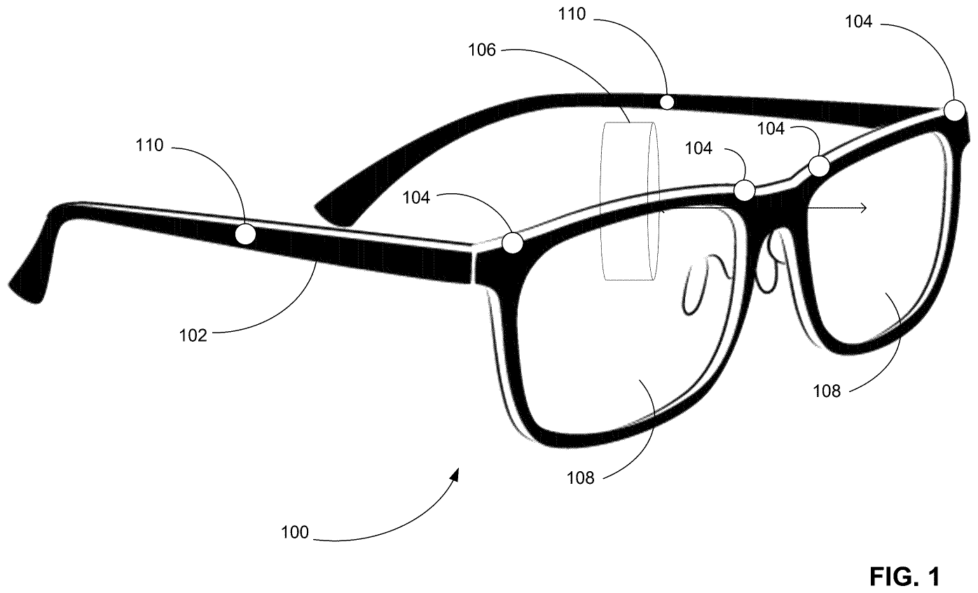

The present disclosure is generally directed to systems and methods of acoustic feedback cancellation utilizing processors configured to perform audio signaling associated with an electronic device, such as smart glasses, or the like. FIG. 1 illustrates an example HMD 100 (e.g., smart glasses) associated with artificial reality content. Artificial reality (AR) is a form of reality that has been adjusted in some manner before presentation to a user, which may include, for example, a virtual reality, an augmented reality, a mixed reality, a hybrid reality, or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer). Additionally, in some instances, artificial reality may be associated with applications, products, accessories, services, or some combination thereof, that may be used to, for example, create content in an artificial reality or are otherwise used in (e.g., to perform activities in) an artificial reality. HMD 100 may include frame 102 (e.g., an eyeglasses frame), a camera 104, a display 108, and an audio device 110 (e.g., speakers/microphone). Display 108 may be configured to direct images to a surface 106 (e.g., a user's eye or another structure). In some examples, HMD 100 may be implemented in the form of augmented-reality glasses. Accordingly, display 108 may be at least partially transparent to visible light to allow the user to view a real-world environment through the display 108. The audio device 110 (e.g., speakers/microphones) that may provide audio associated with augmented-reality content to users and capture audio signals.

Tracking of surface 106 may be beneficial for graphics rendering or user peripheral input. In many systems, HMD 100 design may include one or more cameras 104 (e.g., a front facing camera(s) away from a user or a rear facing camera(s) towards a user). Camera 104 may track movement (e.g., gaze) of an eye of a user or line of sight associated with user. HMD 100 may include an eye tracking system to track the vergence movement of the eye of a user. Camera 104 may capture images or videos of an area, or capture video or images associated with surface 106 (e.g., eyes of a user or other areas of the face) depending on the directionality and view of camera 104. In examples where camera 104 is rear facing towards the user, camera 104 may capture images or videos associated with surface 106. In examples where camera 104 is front facing away from a user, camera 104 may capture images or videos of an area or environment. HMD 100 may be designed to have both front facing and rear facing cameras (e.g., camera 104). There may be multiple cameras 104 that may be used to detect the reflection off of surface 106 or other movements (e.g., glint or any other suitable characteristic). Camera 104 may be located on frame 102 in different positions. Camera 104 may be located along a width of a section of frame 102. In some other examples, the camera 104 may be arranged on one side of frame 102 (e.g., a side of frame 102 nearest to the eye). Alternatively, in some examples, the camera 104 may be located on display 108. In some examples, camera 104 may be sensors or a combination of cameras and sensors to track one or more eyes (e.g., surface 106) of a user.

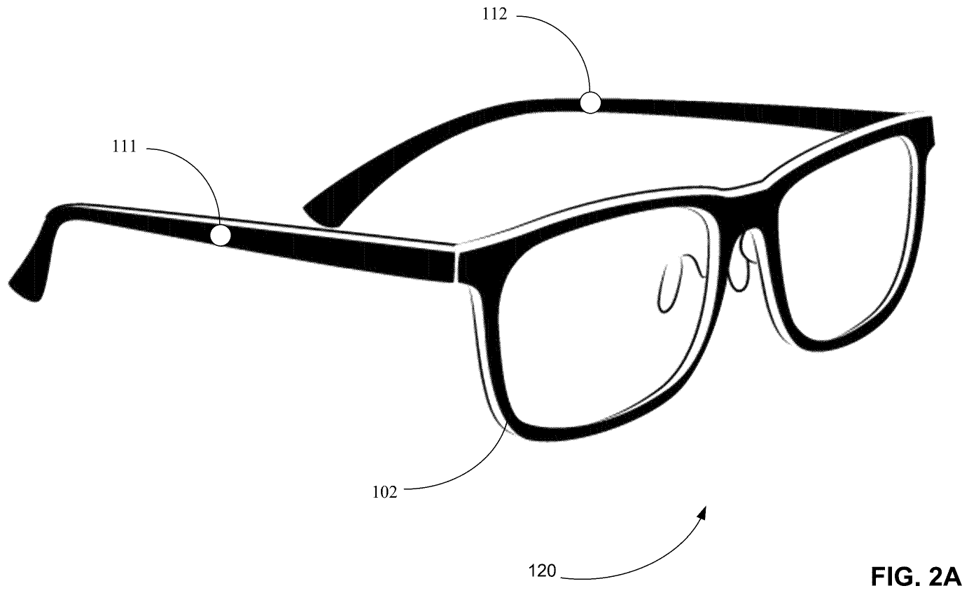

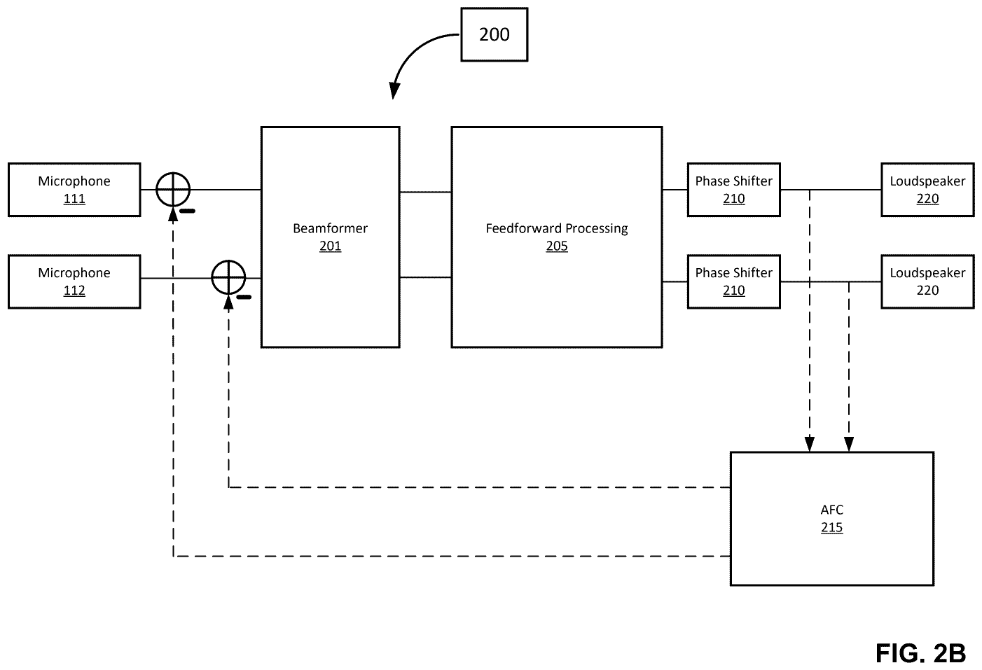

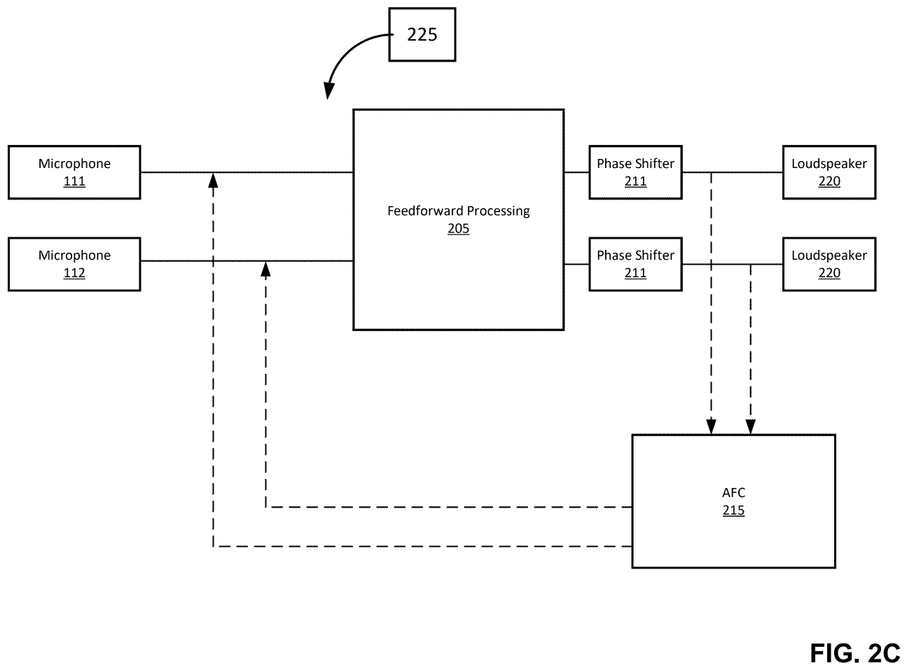

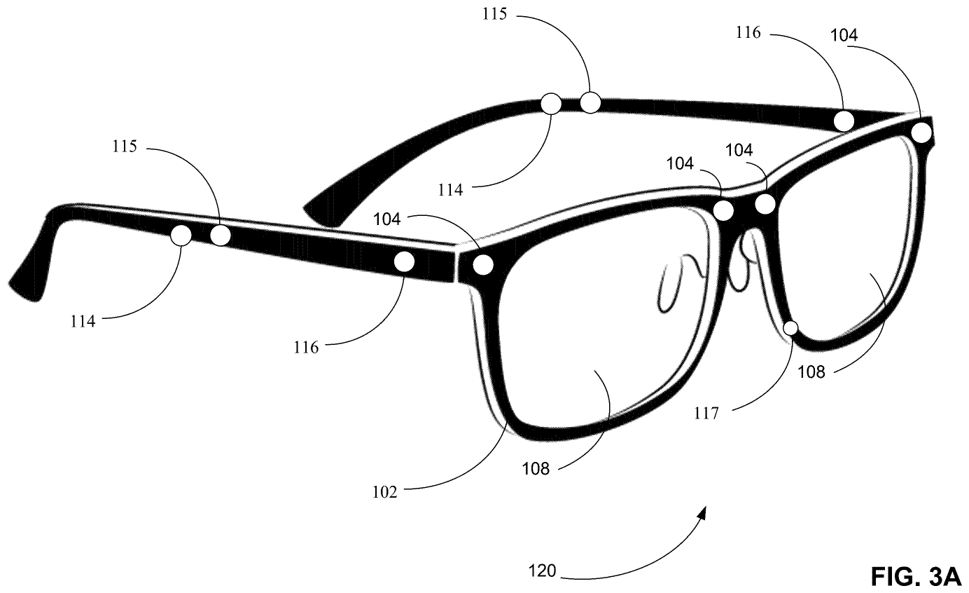

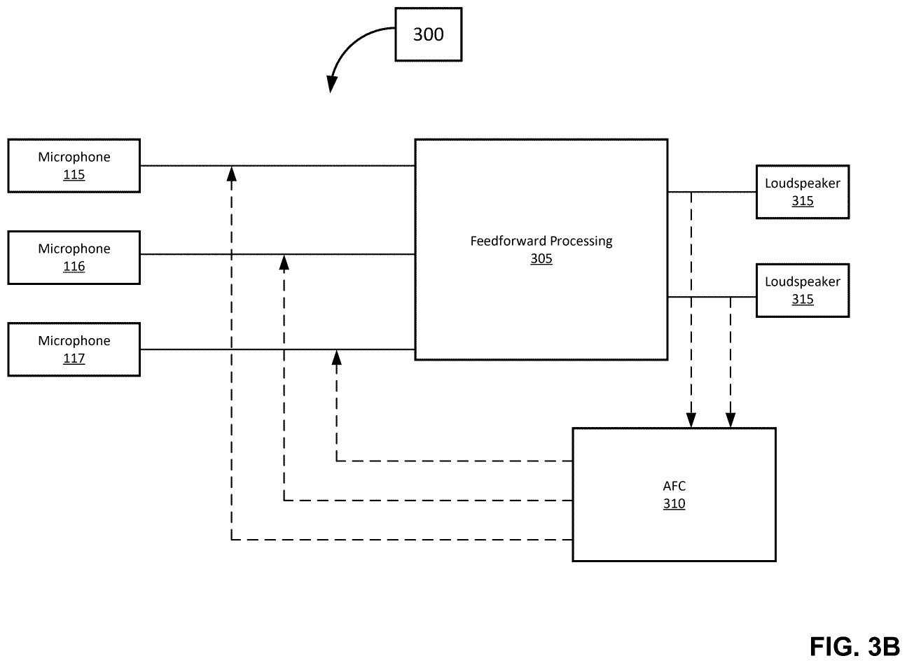

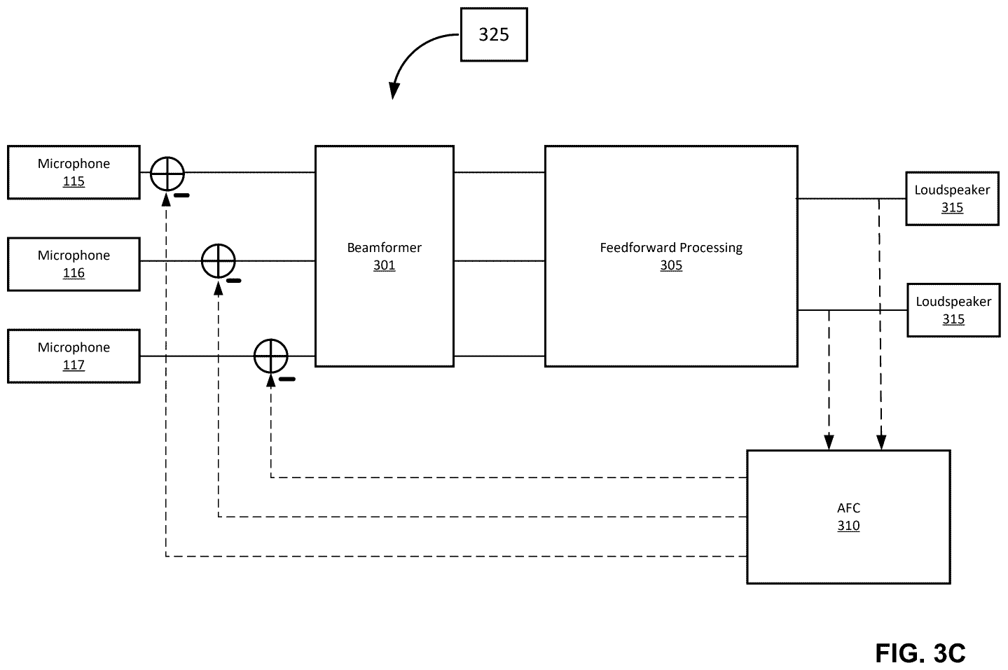

Audio device 110 may be located on frame 102 in different positions or any other configuration such as but not limiting to headphone(s) communicatively connected to HMD 100, a peripheral device, or the like. Audio device 110 may be located along a width of a section of frame 102. In some other examples, the audio device may be arranged on sides of frame 102 (e.g., a side of frame 102 nearest to the ear). In some examples, audio device 110 may be one or more of speakers, microphones, sensors, or the like, or any combination thereof, to capture and produce sound associated with a user. The FIG. 2A may illustrate example locations that an audio device (e.g., audio device 110) may be positioned on the frame 102 associated with a HMD 100 or open ear device 120. The FIG. 3A may further illustrate alternative example locations that an audio device (e.g., audio device 110) may be positioned on the frame 102 associated with a HMD 100 or open ear device 120.

FIG. 2A, illustrates an example open ear device 120 with varying transducer locations, in which a transducer may refer to any type of device that either converts an electrical signal into sound waves (e.g., a loudspeaker) or converts a soundwave into an electrical signal (e.g., a microphone). The open ear device 120 of FIG. 2A may comprise any of the devices and/or features of FIG. 1 such as, for example, frame 102 (e.g., an eyeglasses frame), a camera 104, and a display 108. The audio device (e.g., audio device 110) associated with the device (e.g., open ear device 120) may comprise one or more microphones, loudspeakers, or any combination thereof, located at different points of the frame 102 associated with the open ear device 120, for example the audio device may comprise a first microphone 111, a second microphone 112, and a loudspeaker, where for simplicity the loudspeaker is not illustrated. The first microphone 111 and second microphone 112 associated with the open ear device 120 may be one or more of any suitable microphone such as but not limiting to, Micro-Electro-Mechanical Systems (MEMS) microphones, condenser microphones, dynamic microphones, electret microphones, bone conduction transducers, cartilage conduction transducers, or any combination thereof). It is contemplated, that the first microphone 111 and the second microphone 112 may be located on opposite sides of the frame 102 associated with open ear device 120. It is also contemplated that the first microphone 111 and the second microphone 112 may be positioned anywhere on the frame 102, where the first microphone is a known distance from the second microphone 112. The audio signal captured at the first microphone 111 may be a first audio signal and the audio signal captured at the second microphone 112 may be a second audio signal.

FIG. 2B illustrates an example data pipeline 200 associated with acoustic feedback cancellation. It is contemplated that the process of data pipeline 200 may occur on a chip or processor designed to support audio pathways in a device (e.g., open ear device 120), such that audio signals may be one or more of decoded, amplified, or the like, or any combination thereof. Data pipeline 200 may include a first microphone 111, a second microphone 112, a beamformer (BF) 201, an adaptive feedback canceller (AFC) 215, feedforward processing 205, a phase shifter 210, or a loudspeaker 220 (e.g., loudspeaker 114). The first microphone 111 and the second microphone 112 may be configured to capture a sound wave and convert the sound wave to an electrical signal (e.g., audio signal). The audio signal associated with the first microphone 111 may be discussed herein as a first audio signal, and the audio signal associated with the second microphone 112 may be discussed herein as a second audio signal. In some examples, the first audio signal may be different in acoustic characteristic (i.e., phase, level, or the like, or any combination thereof) when compared to the second audio signal. The first microphone 111 and the second microphone 112 may be in different positions relative to the frame 102 associated with an open ear device 120. In some examples, the data pipeline 200 may have an AFC 215 for the number of microphones associated with the open ear device 120. For example, a first microphone 111 may be associated with a first AFC , and a second microphone 112 may be associated with a second AFC. The AFC 215 may be one or more of an application, algorithm, process, or method utilized for canceling acoustic feedback in a variety of audio devices, such as but not limited to, hearing aids, smart glasses, or the like. Acoustic feedback may be defined as a positive feedback response that may occur when an audio path between an audio input (e.g., a first microphone 111 or a second microphone 112) and an audio output (e.g., a loudspeaker 220, 114) creates an acoustic loop. The positive feedback response may refer to a process in a feedback loop which may exacerbate the effects of small captured audio signals. For example, a small audio signal may be increased in magnitude in an audio system where positive feedback occurs. For example, an audio signal, associated with a talker, is received by a microphone (e.g., the first microphone 111), the audio signal is amplified and passed out of a loudspeaker (e.g., loudspeaker 220, 114), the sound from the loudspeaker (e.g., loudspeaker 220, 114) may then be received by the microphone (e.g., the first microphone 111 or the second microphone 112) again. As such, the audio signal associated with the sound from the loudspeaker may be amplified, and then outputted through the loudspeaker again. The action of the sound from the loudspeaker being captured again through the microphone may result in a howl or distortion of the output associated with the loudspeaker. In some examples, the adaptive feedback management system or AFC may be utilized to mitigate the resultant howl or distortion to mitigate acoustic feedback, where the howl or distortion may be any unwanted sound.

In an example, the first microphone 111 and the second microphone 112 may be configured to convert sound (e.g., a sound wave) to an audio signal. The audio signal at the first microphone 111 may be discussed herein as a first audio signal and the audio signal at the second microphone 112 may be discussed herein as a second audio signal. In some examples, the first audio signal and the second audio signal may be converted to a digital audio signal by an analog-to digital converter (ADC). The ADC may not be illustrated in FIG. 2B for simplicity. The first digital audio signal associated with the first audio signal and the second digital audio signal associated with the second audio signal may be transmitted or transferred to AFC 215. In some examples, the first digital audio signal and the second digital signal may be associated with different AFCs 215. In some examples, the first digital audio signal transmitted or transferred to AFC 215 may undergo a series of estimations, determinations, and processes independently of the second digital audio signal transmitted or transferred to AFC 215. For example, the first digital audio signal and the second digital audio signal may be processed independently at different AFCs 215. For example, the first digital audio signal may be associated with a first AFC 215 and the second digital audio signal may be associated with a second AFC 215.

In an example, AFC 215 may estimate/determine a first transfer function associated with the first digital audio signal and a second transfer function associated with the second digital audio signal. The transfer function (e.g., the first transfer function and the second transfer function) may be a representation (e.g., mathematical representation) of a comparison of two audio signals (e.g., the first audio signal and an audio signal associated with the loudspeaker 220, or the second audio signal and an audio signal associated with the loudspeaker 220) to verify one or more of proper gain, phase, frequency response, or the like, or any combination thereof, through a device (e.g., open ear device 120, audio device 110). In some examples, the transfer function (e.g., the first transfer function and the second transfer function) may be a representation (e.g., mathematical representation) that may define the form of an audio signal associated with an acoustic pathway that the sound of a pulse physically goes through to arrive at a destination (e.g., a microphone) from a source location (e.g., a speaker). For example, AFC 215 associated with the first microphone 111 may function independently of the AFC 215 associated with the second microphone 112.

In an example, the processes associated with AFC 215 may result in (e.g., or output) a first AFC signal and a second AFC signal associated with the first microphone 111 and the second microphone 112, respectively. The first AFC signal may be the first digital audio signal with less noise (e.g., some degree of potential acoustic feedback canceled), and the second AFC may be the second digital audio signal with less noise (e.g., some degree of potential acoustic feedback canceled). In an example, the AFC 215 may filter and adjust the first digital audio signal and the second digital audio signal via an adaptive filter, based on the transfer functions determined and the difference between the first digital audio signal and the second digital audio signal associated with the first microphone and the second microphone, respectively. AFC 215 may filter and adjust the digital audio signal (e.g., the first digital audio signal and the second digital audio signal) to isolate the digital audio signal from acoustic feedback to a resultant digital audio signal, where the resultant digital audio signal may be the digital audio signal associated with the audio signal received at the first and second microphones without acoustic feedback. For example, there may be a first resultant digital audio signal associated with the first audio signal and a second resultant digital audio signal associated with the second audio signal. In some examples, the difference between the first digital audio signal and the second digital audio signal may be programmed, known, and/or stored to the system, via a database.

In an example, the resultant digital audio signals may be transmitted to a BF 201, wherein the BF 201 may be configured to combine the resultant digital audio signals (e.g., the first resultant digital audio signal and the second resultant digital audio signal). The BF 201 may be configured to determine from the received resultant digital audio signals, which direction associated with the resultant digital audio signals may be associated with a target audio. In an example, BF 201 may process the resultant digital audio signals by applying specific weights to one or more directional inputs associated with the resultant digital audio signals, which may be determined based on a target direction of the target audio (e.g., sound source). In an example, the specific weights may be used to adjust the phase and amplitude of the resultant digital audio signals, ensuring that sounds from the target direction are reinforced while sounds from other directions are attenuated. In some examples, the BF 201 may be symmetric mono beamformer, which may combine the resultant digital audio signals in the target direction outputting a single digital audio signal.

In an example, following BF 201, the single digital audio signal may then undergo feedforward processing 205, wherein feedforward processing 205 may be any audio pathway that leads to converting the digital audio signal to an audio signal capable of relaying sound to a user. The audio pathway associated with feedforward processing 205 may lead to having an audio signal associated with the target audio, where the target audio may be suitable to be played via a loudspeaker 220 to a user. Feedforward processing 205 may include, but is not limited to, amplifying, encoding, decoding, noise reduction, equalization, dynamic range compression, or the like, or any combination thereof. It is contemplated that, in some examples, feedforward processing 205 may include a digital-to-analog converter (DAC) such that the target digital audio signal may be converted to a target audio signal. In an example, following feedforward processing 205, the single digital audio signal (e.g., the target audio signal) may be duplicated via a signal splitter or any other suitable process. As such, the signal splitter may transmit or transfer two identical digital audio signals (e.g., two identical target audio signals) to a phase shifter 210. In an example, the phase shifter 210 may be a fixed phase shifter, wherein the phase shifter 210 may be configured to invert one of the two identical digital audio signals. The result of the phase shifter 210 may be a bi-mono signal, where the bi-mono signal may be a duplicated and phase inverted digital audio signal, that may be identical but out-of-phase signals, therefore the bi-mono signals may carry the same audio content (e.g., target audio signal) but with opposite phases. In some examples, the fixed phase may be any phase to differentiate between the first audio signal and the second audio signal based on a position relative to the frame 102 associated with open ear device 120. The fixed phase may be determined by a user or via settings associated with a device (e.g., open ear device 120).

FIG. 2C illustrates example data pipeline 225 associated with cross feedback cancellation. It is contemplated that the processes of data pipeline 225 may occur on a chip or processor designed to support audio pathways in a device (e.g., open ear device 120), such that audio signals may be decoded, amplified, or the like. Data pipeline 225 may include a first microphone 111, a second microphone 112, a AFC 215, and feedforward processing 205, phase shifter 211, or a loudspeaker 220. The first microphone 111 and the second microphone 112 may be configured to capture a sound wave and convert the sound wave to an electrical signal (e.g., audio signal). The audio signal associated with the first microphone 111 may be discussed herein as a first audio signal, and the audio signal associated with the second microphone 112 may be discussed herein as a second audio signal. In some examples, the first audio signal may be different in acoustic characteristic (i.e., phase, level, or the like, or any combination thereof) when compared to the second audio signal. The first microphone 111 and the second microphone 112 may be in different positions relative to the frame 102 associated with an open ear device 120. In the example of FIG. 2C, the first microphone 111 may be positioned on a frame 102 at a first position, where the first position is on a first side of an open ear device 120 (e.g., a left side). Conversely, the second microphone 112 may be positioned on the frame 102 at a second position, where the second position is on a second side of an open ear device 120 (e.g., a right side). It is contemplated that the first position and the second position may be on opposite sides of the open ear device 120. In some examples, the data pipeline 225 may have an AFC 215 for the number of microphones associated with the open ear device 120. For example, a first microphone 111 may be associated with a first AFC 215, and a second microphone 112 may be associated with a second AFC 215. The AFC 215 may be one or more of an application, algorithm, process, or method utilized for canceling acoustic feedback in a variety of audio devices, such as but not limited to, hearing aids, smart glasses, or the like. For example, an audio signal received by a microphone (e.g., first microphone 111 and second microphone 112) is amplified and passed out of a loudspeaker (e.g., loudspeaker 220), the sound from the loudspeaker may then be received by the microphone again, thus amplifying the audio signal associated with the sound from the loudspeaker further, and then passed out through the loudspeaker again. The action of the sound from the loudspeaker being captured again through the microphone may result in a howl or distortion of the output associated with the loudspeaker. The resultant howl or distortion may be an unwanted sound at which the AFC 215 may be configured to mitigate.

In an example, the first microphone 111 and the second microphone 112 may be configured to convert sound (e.g., a sound wave) to an audio signal. The audio signal at the first microphone 111 may be discussed herein as a first audio signal and the audio signal at the second microphone 112 may be discussed herein as a second audio signal. In some examples, the first audio signal and the second audio signal may be converted to digital audio signal by an ADC. The ADC may not be illustrated in FIG. 2C for simplicity. The first digital audio signal associated with the first audio signal and the second digital audio signal associated with the second audio signal may be received by AFC 215. In some examples, the first digital audio signal and the second digital data may be associated with different AFCs 215. In some examples, the first digital audio signal transmitted or transferred to AFC 215 may undergo a series of estimations, determinations, and processes independently of the second digital audio signal transmitted or transferred to AFC 215. In an example, the series of estimations and processes may be configured to estimate the feedback associated with the first digital audio signal and the second digital audio signal, where the estimated feedback may be subtracted from the first digital audio signal and the second digital audio signal before being transmitted to the feedforward processing architecture (e.g., feedforward processing 205).

The received audio signals (e.g., the first digital audio signal and the second digital audio signal) may undergo feedforward processing (e.g., feedforward processing 205), wherein each of the received audio signals (e.g., the first digital audio signal and the second digital audio signal) may be processed independently. Following feedforward processing 205, the audio signals may be transmitted or transferred to a phase shifter (e.g., phase shifter 211), where the audio signal may be shifted. In some examples, the audio signals may also be transmitted or transferred back to AFC 215 for adaptation of the AFC 215 (e.g., adjusting an estimated transfer function). Phase shifter 211 may be a dynamic time-varying phase offset, wherein the phase of a first audio signal or the phase of the second audio signal may be shifted based on the position of the first microphone and the second microphone respectively, where the phase of the first audio signal and the second audio signal may shift with time. The dynamic phase shift may be any suitable frequency shift such that the phase of the first audio signal associated with a first side and the phase of the second audio signal associated with the second side are not the same. The dynamic phase shift may be any known frequency value to the system, for example, the first side may be phase shifted 9 Hz whereas the second side may be phase shifted 12 Hz. The phase shifter 211 may allow for differentiation between the first audio signal and the second audio signal associated with a first microphone 111 and the second microphone 112, respectively. The phase shifted audio signals may be transmitted or transferred to a first AFC associated with the first microphone 111 and a second AFC associated with the second microphone 112. It is contemplated that there may be any number of arrangements between a microphone (e.g., first microphone 111 and second microphone 112) and an AFC 215, wherein there may be ‘N’ microphones and ‘N’ AFCs, at which an audio signal may be transmitted or transferred. Digital audio signal data transmitted or transferred to AFC (e.g., AFC 215) may undergo a series of \estimations, determinations, and processes, wherein the two or more AFCs may estimate a transfer function. Transfer functions may be a representation (e.g., mathematical representation) of a comparison of the first digital audio signal and the second digital audio signal to verify proper gain, phase, and/or frequency response through a device (e.g., audio device 110 or open ear device 120).

The result the processes associated with AFC 215 may be a first AFC signal and a second AFC signal associated with the first microphone 111 and the second microphone 112, respectively. In an example, the first AFC signal and the second AFC signal may respectively have less noise (e.g., some degree of potential acoustic feedback canceled). The AFC signals (e.g., the first AFC signal and the second AFC signal) may then undergo feedforward processing 205, wherein feedforward processing 205 may be any audio pathway that leads to the playing of sound, via one or more loudspeaker 220, to a user, such as but not limited to amplifying, decoding, or any other suitable process. It is contemplated that there may be one or more loudspeakers positioned on opposing sides (e.g., a first loudspeaker associated with a first side and a second loudspeaker associated with a second side) of the device (e.g., HMD 100) associated with data pipeline 225 It is contemplated that, in some examples, feedforward processing 205 may include a DAC such that the target digital audio signal that has been processed via the pipeline 225 may be converted to a target audio signal.

FIG. 3A illustrates an example open ear device 120 with varying transducer locations, in which a transducer may refer to any type of device that either converts an electrical signal into sound waves (e.g., a loudspeaker) or converts a soundwave into an electrical signal (e.g., a microphone). The open ear device 120 of FIG. 3A may comprise any of the devices and/or features of FIG. 1 such as, for example, frame 102 (e.g., an eyeglasses frame), one or more cameras 104, and one or more displays 108. The audio device (e.g., audio device 110) associated with the device (e.g., open ear device 120) may comprise a number of microphones and loudspeakers located at different points of the frame 102 associated with the open ear device 120, for example the audio device may comprise a first microphone 115, a second microphone 116, a third microphone 117, and a loudspeaker 114. The one or more microphones associated with the open ear device 120 (e.g., the first microphone 115, the second microphone 116, and the third microphone 117) may be one or more of any suitable microphone such as but not limiting to, Micro-Electro-Mechanical Systems (MEMS) microphones, condenser microphones, dynamic microphones, electret microphones, bone conduction transducers, cartilage conduction transducers, or any combination thereof). The first microphone 115 may be positioned on the frame (e.g., frame 102) at a first position associated with the open ear device 120. The first microphone 115 may be positioned a first distance from the loudspeaker 114, wherein the audio signal received by the first microphone 115 (e.g., a first microphone signal) may comprise a high level of acoustic feedback due to the first distance from the loudspeaker. The second microphone 116 may be positioned on the frame (e.g., frame 102) at a second position associated with the open ear device 120. The second microphone 116 may be positioned a second distance from the loudspeaker 114, wherein the audio signal received by the second microphone 116 (e.g., a second microphone signal) may comprise an acoustic feedback that is lower than the acoustic feedback associated with the first audio signal. The third microphone 117 may be positioned on the frame (e.g., frame 102) at a third position associated with the open ear device 120. The third microphone 117 may be positioned a third distance from the loudspeaker 114, wherein the audio signal received by the third microphone 117 (e.g., a third microphone signal) may comprise an acoustic feedback that is lower than the acoustic feedback associated with the first audio signal and/or the second audio signal.

In an example, the first position associated with the first microphone 115 and the second position associated with the second microphone 116 may be positioned on a first side (e.g., a left side) and/or a second side (e.g., right side) of the open ear device 120. The loudspeaker 114 may be located on the first side and/or the second side of the open ear device 120. The first side and the second side may be attached via a third side, wherein the third position is on the third side of the open ear device 120. The third microphone 117 may be positioned on the third side of the open ear device 120. It is contemplated that there may be one or more first microphones 115 at the first position on open ear device 120, wherein one of the one or more first microphones 115 may be associated with the first position on the first side and one of the one or more first microphones 115 may be associated with the first position on the second side of the open ear device 120. For example, there may be two first microphones 115, where one first microphone 115 is on the first side and the other first microphone 115 is on the second side of the open ear device 120. As such, both of the two first microphones 115 may be at the first position relative to the first and/or second side of the open ear device 120. It is contemplated that there may be one or more second microphones 116 at the second position on the open ear device 120, wherein one of the one or more second microphones 116 may be associated with the second position on the first side and one of the one or more second microphones 116 may be associated with the second position on the second side of the open ear device 120. For example, there may be two second microphones 116, where one second microphone 116 is on the first side and the other second microphone 116 is on the second side of the open ear device 120. As such, both of the two second microphones 116 are at the second position relative to the first and/or second side of the open ear device 120. In some examples, the first position and the second position may be fixed positions on the first side and/or second side of the open ear device 120. In some examples, the loudspeaker 114 may be proximal to the first position and distal to the second position. In some examples, there may be a technical advantage in instance in which the locations of the first microphone and the second microphone on a left side are identical to the locations of the first microphone and the second microphone on the right side (e.g., mirrored).

FIG. 3B illustrates data pipeline 300 associated with acoustic feedback cancellation. It is contemplated that the process of data pipeline 300 may occur on a chip or processor designed to support audio pathways in a device, such that audio signals may be decoded, amplified, or the like. Data pipeline 300 may include a first microphone 115, a second microphone 116, a third microphone 117, a AFC 310, feedforward processing 305, or loudspeaker 315. A first microphone 115 may be located a first distance from a loudspeaker 315 (e.g., loudspeaker 114), a second microphone 116 may be located a second distance from the loudspeaker 315, and a third microphone may be located a third distance from the loudspeaker 315. It is contemplated that the first, second, and third distances from the loudspeaker are known and static distances that may introduce a known difference between the first, second, and third audio signal received at the first, second, and third microphone, respectively. The first, second, and third distance may be any increment of distance away from the loudspeaker 114 and the other microphones. Each of the first audio signal, the second audio signal, and the third audio signal may be different in acoustic characteristic (i.e., phase, level, or the like, or any combination thereof). It is contemplated that the first, second, and third microphones may not be positioned on the same spot on the frame 102 of an open ear device 120.

The first microphone 115, the second microphone 116, and the third microphone 117 may be configured to capture a sound wave and convert the sound wave to an electrical signal (e.g., audio signal). The audio signal associated with the first microphone 115 may be discussed herein as a first audio signal, the audio signal associated with the second microphone 116 may be discussed herein as a second audio signal, and the audio signal associated with the third microphone 117 may be discussed herein as a third audio signal. In some examples, the first audio signal may be different in acoustic characteristic (i.e., phase, level, or the like, or any combination thereof) when compared to the second audio signal or the third audio signal. In some examples, the second audio signal may be different in acoustic characteristic (i.e., phase, level, or the like, or any combination thereof) when compared to the first audio signal or the third audio signal. In some examples, the third audio signal may be different in acoustic characteristic (i.e., phase, level, or the like, or any combination thereof) when compared to the first audio signal or the second audio signal. The first microphone 115, the second microphone 116, and the third microphone may be in different positions relative to the frame 102 associated with an open ear device 120. In some examples, the data pipeline 300 may have an AFC 310 for the number of microphones associated with the open ear device 120. For example, a first microphone 115 maybe associated with a first AFC 310, a second microphone 116 may be associated with a second AFC 310, and a third microphone 117 may be associated with a third AFC 310. The AFC 310 may be one or more of an application, algorithm, process, or method utilized for canceling acoustic feedback in a variety of audio devices, such as but not limited to, hearing aids. Acoustic feedback may be defined as a positive feedback response that may occur when an audio path between an audio input (e.g., a first microphone 115 or a second microphone 116) and an audio output (e.g., a loudspeaker 315, 114) creates an acoustic loop. The positive feedback response may refer to a process in a feedback loop which may exacerbate the effects of small captured audio signals. For example, a small audio signal may be increased in magnitude in an audio system where positive feedback occurs. For example, an audio signal, associated with a talker, is received by a microphone (e.g., the first microphone 115, the second microphone 116, or the third microphone 117), the audio signal is amplified and passed out of a loudspeaker (e.g., loudspeaker 315, 114), the sound from the loudspeaker may then be received by the microphone again. As such, the audio signal associated with the sound from the loudspeaker may be amplified, and then outputted through the loudspeaker again. The action of the sound from the loudspeaker being captured again through the microphone may result in a howl or distortion of the output associated with the loudspeaker. In some examples, the adaptive feedback management system or AFC 310 may be utilized to mitigate the resultant howl or distortion to mitigate acoustic feedback, where the howl or distortion may be any unwanted sound.

The first microphone 115, the second microphone 116 or the third microphone 117 may convert a sound to an audio signal, wherein the audio signal may have varying characteristics (e.g., magnitude, phase, etc.) based on a distance (e.g., a first distance, a second distance, or a third distance associated with the first microphone 115, the second microphone 116, or the third microphone, respectively) of the microphone to the loudspeaker, the audio signal at each microphone (e.g., first microphone signal, second microphone signal, and third microphone signal) may represent the sound received. It is contemplated that the data pipeline 300 may include a ADC configured to convert audio signals to digital audio signal, such that the processes of the data pipeline 300 may be performed. As such the first audio signal, the second audio signal, and the third audio signal may be converted via ADC to a first digital audio signal, a second digital audio signal, and a third digital audio signal, respectively. The first digital audio signal, the second digital audio signal, and the third digital audio signal may be transmitted or transferred to an AFC (e.g., AFC 310). It is contemplated that there may be any number of arrangements between a microphone and an AFC 310, wherein there may be ‘N’ microphones and ‘N’ AFCs, at which an audio signal may be transmitted or transferred. The first digital audio signal, the second digital audio signal, and the third digital audio signal transmitted or transferred to AFC (e.g., AFC 310) may undergo a series of estimations, determinations, and processes independently. The one or more AFCs 310 may estimate a transfer function associated with digital audio signal associated with each of the microphones, wherein the transfer function may be a representation (e.g., mathematical representation) of a comparison of two audio signals (e.g., microphone audio signal and loudspeaker audio signal) to verify proper gain, phase, or frequency response through a device (e.g., audio device). The transfer function may be a representation in the form of an audio signal of an acoustic pathway that the sound of a pulse physically goes through to arrive at the destination (e.g., a microphone) from a source location (e.g., a loudspeaker). For example, the AFC 310 associated with the first microphone may function independently of the AFC 310 associated with the second microphone and the AFC 310 associated with the third microphone 117.

The processes of the AFC (e.g., AFC 310) may output a first AFC signal, a second AFC signal, and a third AFC signal associated with the first microphone 115, the second microphone 116, and the third microphone 117, respectively. A feedback detection mechanism may be utilized to determine a difference between each AFC signal (e.g., the first AFC signal, the second AFC signal, and the third AFC signal). The difference may be determined in comparison to the first audio signal of the first microphone 115 due to an estimated increased acoustic feedback received by the first microphone 115, where the first distance is shorter than the second distance or the third distance. Therefore, the first microphone 115 may be closer to the loudspeaker 315 (e.g., loudspeaker 114), thus the acoustic feedback associated with the first digital audio signal may be estimated to be higher than acoustic feedback associated with the second digital audio signal or the third digital audio signal. The feedback detection mechanism may analyze the first digital audio signal to categorize a list of characteristics associated with the first digital audio signal, wherein the acoustic feedback in the first digital audio signal may be very high compared to other microphone signals (e.g., second digital audio signal and third digital audio signal). The feedback detection mechanism may further combine the difference and the list of characteristics to inform adjustments to the other microphone signals (e.g., the second digital audio signal, the third digital audio signal). The AFC 310 and the feedback detection mechanism may filter and adjust, based on the transfer functions and the difference between the first audio signal, the second audio signal, the third audio signal, and a target audio signal. The target audio signal may be an amplified sound associated with the received sound. In some examples, the difference between one or more microphones (e.g., first microphone 115, second microphone 116, or third microphone 117) may be programmed and known to the system based on an estimated difference in sound capture based on the distance of the microphone to the loudspeaker, and the distance between one or more microphones. The result of AFC 310 may be a resultant signal(s), where the resultant signals may be each of the audio signals (e.g., first digital audio signal, second digital audio signal, and third digital audio signal) with less noise (e.g., some degree of potential acoustic feedback canceled).

The audio signal may then undergo feedforward processing 305, wherein feedforward processing 305 may be any audio pathway that leads to the playing of sound, via a loudspeaker 315 (e.g., loudspeaker 114), to a user, such as but not limited to, amplifying, decoding, or any other suitable process. It is contemplated that there may be one or more loudspeakers (e.g., loudspeaker 315) associated with data pipeline 300.

FIG. 3C illustrates an alternate example block diagram of an example data pipeline 325 associated with acoustic feedback cancellation. It is contemplated that the process of data pipeline 325 may occur on a chip or processor designed to support audio pathways in a device, such that audio signals may be decoded, amplified, or the like. Data pipeline 325 may include a first microphone 115, a second microphone 116, a third microphone 117, a AFC 310, feedforward processes 305, or loudspeaker 315. A first microphone 115 may be located a first distance from a loudspeaker 315 (e.g., loudspeaker 114), a second microphone 116 may be located at second distance from the loudspeaker 315, and a third microphone may be located at a third distance from the loudspeaker 315. It is contemplated that the first, second, and third distances from the loudspeaker are known and static distances that may introduce a known difference between the first, second, and third audio signal received at the first, second, and third microphone, respectively. The first, second, and third distance may be any increment of distance away from the loudspeaker 114 and the other microphones. Each of the first audio signal, the second audio signal, and the third audio signal may be different in acoustic characteristic (i.e., phase, level, or the like, or any combination thereof). It is contemplated that the first, second, and third microphones may not be positioned on the same spot on the frame 102 of an open ear device 120.

The first microphone 115, the second microphone 116, and the third microphone 117 may be configured to capture a sound wave and convert the sound wave to an electrical signal (e.g., audio signal). The audio signal associated with the first microphone 115 may be discussed herein as a first audio signal, the audio signal associated with the second microphone 116 may be discussed herein as a second audio signal, and the audio signal associated with the third microphone 117 may be discussed herein as a third audio signal. In some examples, the first audio signal may be different in acoustic characteristic (i.e., phase, level, or the like, or any combination thereof) when compared to the second audio signal or the third audio signal. In some examples, the second audio signal may be different in acoustic characteristic (i.e., phase, level, or the like, or any combination thereof) when compared to the first audio signal or the third audio signal. In some examples, the third audio signal may be different in acoustic characteristic (i.e., phase, level, or the like, or any combination thereof) when compared to the first audio signal or the second audio signal. The first microphone 115, the second microphone 116, and the third microphone 117 may be in different positions relative to the frame 102 associated with an open ear device 120. In some examples, the data pipeline 325 may have an AFC 310 for the number of microphones associated with the open ear device 120. For example, a first microphone 115 may be associated with a first AFC 310, a second microphone 116 may be associated with a second AFC 310, and a third microphone 117 may be associated with a third AFC 310. The AFC 310 may be one or more of an application, algorithm, process, or method utilized for canceling acoustic feedback in a variety of audio devices, such as but not limited to, hearing aids. A coustic feedback may be defined as a positive feedback response that may occur when an audio path between an audio input (e.g., a first microphone 115 or a second microphone 116) and an audio output (e.g., a loudspeaker 315, 114) creates an acoustic loop. The positive feedback response may refer to a process in a feedback loop which may exacerbate the effects of small captured audio signals. For example, a small audio signal may be increased in magnitude in an audio system where positive feedback occurs. For example, an audio signal, associated with a talker, is received by a microphone (e.g., the first microphone 115, the second microphone 116, or the third microphone 117), the audio signal is amplified and passed out of a loudspeaker (e.g., loudspeaker 315, 114), the sound from the loudspeaker may then be received by the microphone again. As such, the audio signal associated with the sound from the loudspeaker may be amplified, and then outputted through the loudspeaker again. The action of the sound from the loudspeaker being captured again through the microphone may result in a howl or distortion of the output associated with the loudspeaker. In some examples, the adaptive feedback management system or AFC 310 may be utilized to mitigate the resultant howl or distortion to mitigate acoustic feedback, where the howl or distortion may be any unwanted sound.

The first microphone 115, the second microphone 116 or the third microphone 117 may convert a sound to an audio signal, wherein the audio signal may have varying characteristics (e.g., magnitude, phase, etc.) based on a distance (e.g., a first distance, a second distance, or a third distance associated with the first microphone 115, the second microphone 116, or the third microphone 117, respectively) of the microphone to the loudspeaker, the audio signal at each microphone (e.g., first microphone signal, second microphone signal, and third microphone signal) may represent the sound received. It is contemplated that the data pipeline 325 may include a ADC configured to convert audio signals to digital audio signal, such that the processes of the data pipeline 325 may be performed. As such the first audio signal, the second audio signal, and the third audio signal may be converted via ADC to a first digital audio signal, a second digital audio signal, and a third digital audio signal, respectively. The first digital audio signal, the second digital audio signal, and the third digital audio signal may be transmitted or transferred to an AFC (e.g., AFC 310). It is contemplated that there may be any number of arrangements between a microphone and an AFC 310, wherein there may be ‘N’ microphones and ‘N’ AFCs, at which an audio signal may be transmitted or transferred. The first digital audio signal, the second digital audio signal, and the third digital audio signal transmitted or transferred to AFC (e.g., AFC 310) may undergo a series of estimations, determinations, and processes independently. The one or more AFC s may estimate a transfer function associated with digital audio signals associated with each of the microphones, wherein the transfer function may be a representation (e.g., mathematical representation) of a comparison of two audio signals (e.g., microphone audio signal and loudspeaker audio signal) to verify proper gain, phase, and/or frequency response through a device (e.g., audio device). The transfer function may be a representation in the form of an audio signal of an acoustic pathway that the sound of a pulse physically goes through to arrive at the destination (e.g., a microphone (e.g., first microphone 115, second microphone 116, or third microphone 117)) from a certain source location (e.g., a loudspeaker (e.g., loudspeaker 315)). For example, the AFC 310 associated with the first microphone 115 may function independently of the AFC 310 associated with the second microphone 116 and the AFC 310 associated with the third microphone 117.

The processes of the AFC (e.g., AFC 310) may output a first AFC signal, a second AFC signal, and a third AFC signal associated with the first microphone 115, the second microphone 116, and the third microphone 117, respectively. A feedback detection mechanism may be utilized to determine a difference between each AFC signal (e.g., the first AFC signal, the second AFC signal, and the third AFC signal). The difference may be determined in comparison to the signal of the first microphone 115 due to an estimated increased acoustic feedback received by the first microphone 115, where the first distance is shorter than the second distance and the third distance. Therefore, the first distance associated with the first microphone 115 may be closer to the loudspeaker 315 (e.g., loudspeaker 114), thus the acoustic feedback associated with the first digital audio signal may be estimated to be higher than the second digital audio signal and the third digital audio signal. The feedback detection mechanism may analyze the first digital audio signal to categorize a list of characteristics associated with the first digital audio signal, wherein the acoustic feedback in the first digital audio signal may be very high compared to other microphone signals. The feedback detection mechanism may further combine the difference and the list of characteristics to inform adjustments to the other microphone signals (e.g., the second digital audio signal, the third digital audio signal). The AFC 310 and the feedback detection mechanism may filter and adjust, based on transfer functions and the difference between the first audio signal, the second audio signal, the third audio signal, and a target audio signal. The target audio signal may be an amplified sound associated with the received sound. In some examples, the difference between one or more microphones (e.g., first microphone 115, second microphone 116, or third microphone 117) may be programmed and known to the system based on an estimated difference in sound capture based on the distance of the microphone to the loudspeaker, and the distance between one or more microphones. The result of AFC 310 may be a resultant signal(s), where the resultant signals may be each of the audio signals (e.g., first digital audio signal, second digital audio signal, and third digital audio signal) with less noise (e.g., some degree of potential acoustic feedback canceled).

The resultant signals (e.g., first AFC signal, the second AFC signal, and the third AFC signal) may then be received by BF 301, wherein the combination of the resultant audio signals may be processed. BF 301 may be configured to determine from the received audio signals, which audio signal is the target or targeted audio, and in response BF 301 may enhance the digital audio signals associated with a microphone (e.g., first microphone 115, second microphone 116, or third microphone 117) or direction. As such, the other received resultant signals may be determined to be noise. In some examples, BF 301 may be configured to determine a target audio based on the received audio signals from at least one AFC (e.g., AFC 310). In some examples, BF 301 may also reduce noise in the audio signal based on the determination of the target audio. In some examples, AFC 310 may filter, via an adaptive filter, one or more digital audio signals via BF 301, where digital audio signals may have been filtered via AFC 310 associated with each microphone (e.g., first microphone 115, second microphone 116, or third microphone 117) independently. In some alternate examples, BF 301 may be configured to take one or more digital audio signals captured by multiple transducers (e.g., first microphone 115, second microphone 116, and third microphone 117) placed at different locations (e.g., a first distance, a second distance, and a third distance, respectively) to leverage distinct spatial information associated with resultant signals arising from the difference in a microphones' position on the frame 102 to enhance the target signal coming through the audio pathway associated with the target source location. This may be achieved by labeling the path from the target source location (e.g., target audio associated with an audio signal and all the other paths associated with non-target locations separately). Paths labeled as non-target locations may then be determined to be noise, wherein the BF 301 may cancel sounds coming through such non-target paths, while enabling the audio signals associated with the target audio to pass through the BF 301.

In some examples, the target audio signal may be filtered by a BF 301 or an adaptive filter (a component of AFC 310), wherein at particular frequencies associated with the received audio signal the processes of data pipeline 325 may determine to adjust the received audio signal to the target audio signal (e.g., remove acoustic feedback) based on the characteristics associated with the received audio signal. For example, when the audio signal is representative of a low frequency the data pipeline may adjust the received audio via BF 301, conversely, when the audio signal received is representative of a high frequency the audio signal may be adjusted via an adaptive filter. The audio signal may then undergo feedforward processing 305, wherein feedforward processing 305 may be any audio pathway that leads to the playing of sound, via a loudspeaker (e.g., loudspeaker 315 (e.g., loudspeaker 114)), to a user, such as but not limited to amplifying, decoding, or any other suitable process. It is contemplated that there may be one or more loudspeakers (e.g., loudspeaker 315 (e.g., loudspeaker 114)) associated with data pipeline 325.

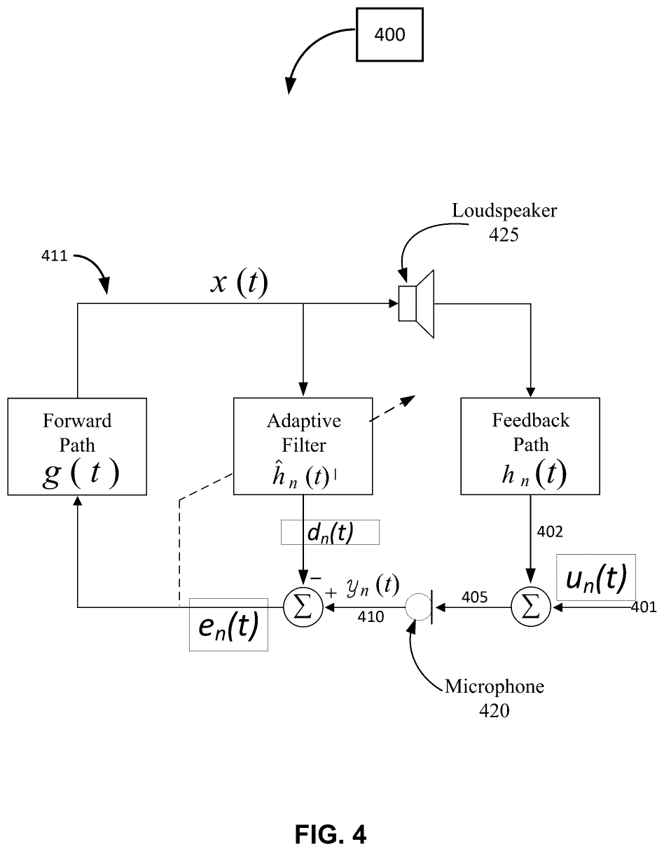

FIG. 4 illustrates an example block diagram of adaptive feedback cancellation associated with one or more estimated transfer functions. For simplicity one microphone (e.g., microphone 420) and one loudspeaker (e.g., loudspeaker 425) are illustrated in FIG. 4, but it is contemplated that there may be ‘N’ number of microphones and ‘M’ number of speakers that may perform the processes of the FIG. 4. AFC 400 may illustrate an arrangement of a loudspeaker 425 and a microphone 420. The AFC 400 may receive an input 405 (e.g., an audio signal) via two or more microphones (e.g., first microphone 115, second microphone 116, third microphone 117). The microphone 420 may comprise two audio signals (e.g., inputs (yₙ(t)), wherein one input may be an incoming audio signal 401 (Uₙ(t)) and an acoustic feedback 402 (hₙ(t), due to the coupling between the loudspeaker 425 and the microphone 420 signals, wherein t is a function of time. The acoustic feedback 402 may be first estimated by using an adaptive filter (hₙ̅(t), wherein the adaptive filter may comprise processes for estimating a transfer function, then the estimated transfer function may be summed, producing (eₙ(t)), wherein eₙ(t) may be sent to the adaptive filter to update the estimate of hₙ̅(t). The adaptive filter may comprise an algorithm, model, or equations that may determine a coefficient scaled by a value associated with maximum forward gain, wherein the value may be dependent on a target gain associated with the device. The estimated feedback path may be used to compute the estimated feedback contribution (dₙ(t)) which is subtracted from the microphone 410 signal (yₙ(t), producing an error signal (eₙ(t), wherein the error signal may be utilized to update the adaptive filter, as denoted by the dotted line illustrated in FIG. 4. This error signal may be utilized for the adaptive estimate of the acoustic feedback 402 path and computed as eₙ(t)=yₙ(t)−(dₙ(t)). Further the speaker signal (e.g., audio signal received at the loudspeaker 425) is equal to the error signal processed by the feedforward path (g(t)), resulting in an target audio 411 or speaker signal (e.g., x(t), wherein the feedforward path (e.g., feedforward processes 305) may comprise any form of processing necessary for the audio pathway associated with the audio device. It may be seen that the estimate of the feedback path may include a bias which may depend on the correlation between the loudspeaker 425 and incoming audio signals received via one or more microphones 420, allowing for the incoming signal to behave or cause a disturbance, distortion, or the like to AFC 400.

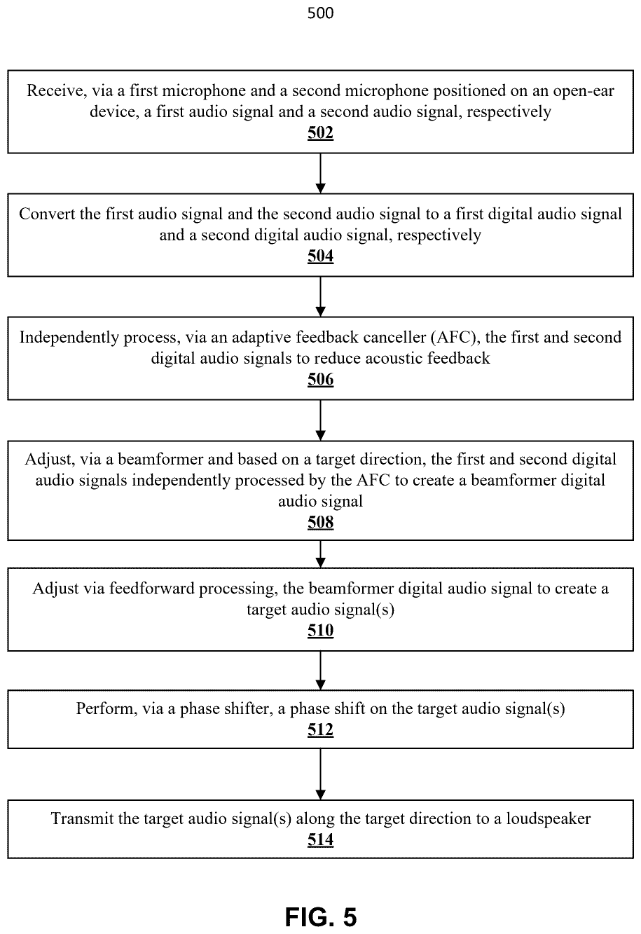

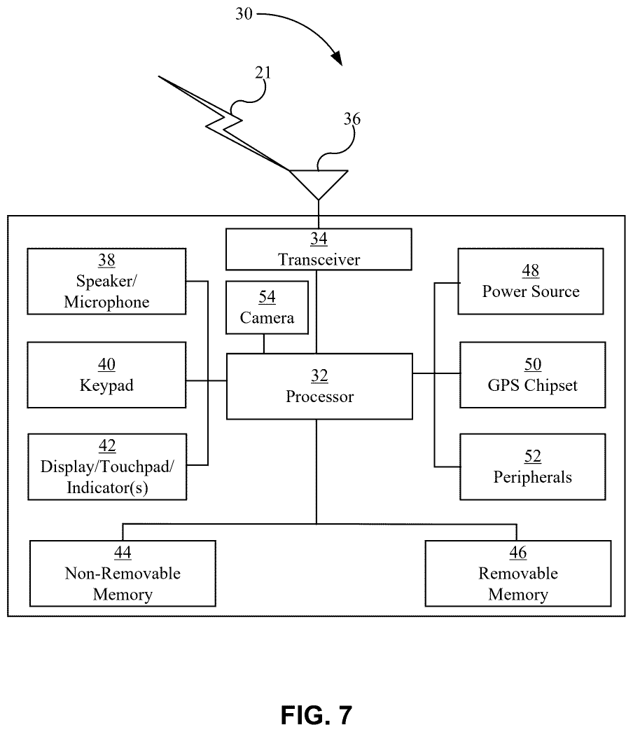

FIG. 5 illustrates an example method 500 according to an aspect of the subject technology. The method 500 may comprise a computer implemented method for mitigating acoustic feedback. A system and/or computing environment, such as, for example, the HMD 100 of FIG. 1, open ear device 120 of FIG. 2A, open ear device 120 of FIG. 3A, and/or the computing environment of FIG. 7, may be configured to perform the method 500. The method 500 may be performed in connection with the HMD 100 illustrated in FIG. 1, the open ear device 120 illustrated in FIG. 2A, or open ear device 120 FIG. 3A. Any step or combination of steps of the method 500 may be performed by a user device (e.g., HMD 100 or open ear device 120), a server, a processor (e.g., processor 32), or any combination thereof.

At step 502, a first audio signal and a second audio signal may be received. The first audio signal, the second audio signal, and the third audio signal may be received via a first microphone (e.g., first microphone 111) and a second microphone (e.g., second microphone 112) microphone, respectively. The first microphone 111 and the second microphone 112 may be positioned on the open ear device 120. The first microphone 111 may be positioned at a first position associated with the open ear device 120, and the second microphone 112 may be positioned at a second position associated with the open ear device 120. In an example, the first position may be on a first side of the open ear device 120 (e.g., a left side), and the second position may be on a second side of the open ear device 120 (e.g., a right side). In some examples, the first side (e.g., the left side) and the second side (e.g., the right side) may be attached via a third side of the open ear device 120. It is contemplated that the first position and the second position may be positioned on any suitable portion or side associated with open ear device 120. It is further contemplated that the first microphone 111 and second microphone 112 need not be positioned on opposing sides of the open ear device 120. In some alternative examples, the first position and the second position may be determined based on a distance from a loudspeaker (e.g., loudspeaker 220). In an example, the loudspeaker 220 may be positioned on the open ear device 120.

At step 504, the first audio signal and the second audio signal may be converted to a first digital audio signal and a second digital audio signal, respectively. In some examples, an ADC convert may be utilized to convert the first audio signal to the first digital audio signal, and the second audio signal to the second digital audio signal.

At step 506, the first digital audio signal and the second digital audio signal may be independently processed, via an adaptive feedback canceller (AFC) (e.g., AFC 215). For example, the first digital audio signal associated with the first microphone 111 may be associated with a first AFC, and the second digital audio signal associated with the second microphone 112 may be associated with a second AFC. In an example, AFC 215 may be one or more of an application, algorithm, process, or method utilized for canceling (e.g., mitigating) acoustic feedback associated with a device (e.g., open ear device 120). A coustic feedback may be a positive feedback response that may occur when an audio path between an audio input (e.g., a first microphone 111 or a second microphone 112) and an audio output (e.g., a loudspeaker 220) creates an acoustic loop. The positive feedback response may refer to a process in a feedback loop (e.g., acoustic loop) which may exacerbate the effects of small captured audio signals. For example, an audio signal may be received by a first microphone 111 and/or a second microphone 112, the audio signal is amplified and passed out of a loudspeaker 220, the sound from the loudspeaker 220 may then be received by the microphone again. As such, the audio signal associated with the sound from the loudspeaker 220 may be amplified, and then outputted through the speaker again. The action of the sound from the loudspeaker 220 being captured again through the microphone (e.g., first microphone 111 or second microphone 112) may result in a howl or distortion of the output associated with the loudspeaker 220. In some examples, AFC 215 may be utilized to mitigate the resultant howl or distortion to mitigate acoustic feedback, where the howl or distortion may be any unwanted sound.

In an example, AFC 215 may estimate a first transfer function associated with the first digital audio signal and a second transfer function associated with the second digital audio signal. The transfer functions (e.g., the first transfer function and the second transfer function) may be a representation (e.g., mathematical representation) of a comparison of two audio signals (i.e., the first audio signal and an audio signal (e.g., resultant howl) associated with the loudspeaker 220, or the second audio signal and an audio signal associated with the loudspeaker 220) to verify one or more of a proper gain, phase, frequency response, or the like, or any combination thereof, through the open ear device 120. In some examples, the transfer functions may be a representation (e.g., mathematical representation) that may define the form of an audio signal associated with an acoustic pathway that the sound of a pulse physically goes through to arrive at a destination (e.g., a microphone) from a certain source location (e.g., a loudspeaker).

In an example, the AFC 215 may filter and adjust the first digital audio signal and the second digital audio signal via an adaptive filter, based on the transfer functions (e.g., the first transfer function and the second transfer function) determined and the difference between the first digital audio signal and the second digital audio signal associated with the first microphone and the second microphone, respectively. AFC 215 may filter and adjust the digital audio signals (e.g., the first digital audio signal and second digital audio signal) to isolate the digital audio signals from acoustic feedback to a resultant digital audio signal, where the resultant digital audio signal may be the digital audio signals (e.g., the first digital audio signal and the second digital audio signal) associated with the first microphone 111 and the second microphone 112 without acoustic feedback. For example, the processes associated with AFC 215 may result in (e.g., or output) the first digital audio signal with mitigated acoustic feedback (e.g., a first resultant signal) and the second digital audio signal with mitigated acoustic feedback (e.g., a second resultant signal). The first AFC signal may be the first digital audio signal with less noise (e.g., some degree of potential acoustic feedback canceled), and the second AFC may be the second digital audio signal with less noise (e.g., some degree of potential acoustic feedback canceled). In some examples, the difference between the first digital audio signal and the second digital audio signal may be programmed, known, and/or stored to the system, via a database.

At step 508, the first digital audio signal and the second digital audio signal independently processed by the AFC of step 506 may be adjusted. The first digital audio signal and second digital audio signal independently processed may be adjusted to create beamformer digital audio signal based on a target direction, via a beamformer (e.g., BF 201). BF 201 may be configured to determine from the first digital audio signal and the second digital audio signals independently processed, via AFC 215, (e.g., resultant digital audio signals) a target direction. The target direction may be determined based on one or more directional inputs associated with the resultant digital audio signals. In an example, BF 201 may process the resultant digital audio signals by applying specific weights to one or more directional inputs associated with the resultant digital audio signals. In some examples, the specific weights may be determined based on the target direction associated with a target. The target may be a sound source associated with the first audio signal and the second audio signal received at step 502.

In an example, the specific weights may be used to adjust the phase and amplitude of the resultant digital audio signals, ensuring that sounds from the target direction are reinforced while sounds from other directions are attenuated. In some examples, the BF 301 may be symmetric mono beamformer, which may combine the resultant digital audio signals (e.g., first digital audio signal and second digital audio data independently processed via AFC 215) in the target direction outputting a single digital audio signal. The single audio signal may be discussed herein as a beamformer digital audio signal. Further at step 508, the beamformer digital audio signal may be duplicated via a signal splitter, or any other suitable process, where the beamformer digital audio signal may be processed via feed forward processing (e.g., feedforward processing 205).

At step 510, the beamformer digital audio signal may be adjusted via feedforward processing (e.g., feedforward processing 205) to create a target audio signal. In an example, feedforward processing 205 may be any audio pathway that leads to the playing of sound (e.g., playing of the target audio), via a loudspeaker 220, where the loudspeaker 220 may be positioned on the open ear device 120. Feedforward processing 205 may include, but not limited to, amplifying, encoding, decoding, noise reduction, equalization, dynamic range compression, or the like, or any combination thereof. It is contemplated that, in some examples, feedforward processing 205 may include a DAC such that the target digital audio signal that has been processed may be converted to a target audio signal. In an example, following feedforward processing 205, the target audio signal may be duplicated via a signal splitter or any other suitable process. As such, the signal splitter may transmit or transfer two identical target audio signals to a phase shifter (e.g., phase shifter 210).

At step 512, a phase shift of the target audio signal may be performed via a phase shifter (e.g., phase shifter 210). For simplicity, the two target audio signals may now be referred to as a first target audio signal and a second target audio signal. In an example, the first target audio signal and second target audio signal may be audio signals comprising identical audio content. In an example, the phase shifter 210 may be configured to shift one or more of the first target audio signal and the second digital audio signal. In some examples, one of the first target audio signal and second target audio signal may be inverted. In some other examples, the phase shifter 210 may be configured to shift the first target audio signal and second target audio signal by a known phase based on the first position associated with the first microphone 111 and a second position associated with the second microphone 112 on the open ear device 120. For example, the first target audio signal associated with the first microphone 111 at the first position may be inverted (e.g., shifted 180 degrees), whereas the second target audio signal associated with the second microphone 112 at the second position may not be phase shifted based on the position of the second microphone 112.

At step 514, the target audio signal may be transmitted to the loudspeaker 220. The target audio signal may be associated with and transmitted along the target direction, wherein the target audio signal may be derived or processed from the first audio signal and the second audio signal of step 502 associated with a target (e.g., sound source).

For example, a user wearing an open ear device (e.g., open ear device 120) is in a crowded room and is conversing with a talker sitting across from the user. The user may be struggling to hear the talker normally due to the noise associated with the crowded room. As such, the user may utilize the open ear device 120 to mitigate the noise associated with acoustic feedback and the crowded room. The open ear device 120 may receive a first and second audio signals associated with a target sound (e.g., sound associated with the target) and surrounding sounds (e.g., sounds from the crowded room). The first and second audio signals may be converted to a first digital audio signal and a second digital audio signal, respectively. The first and second digital audio signals may be transmitted to a AFC (e.g., AFC 215). AFC 215 may determine transfer functions associated with the first and second digital audio signals. AFC 215 may mitigate (e.g., remove or cancel) the acoustic feedback associated with the first and second digital audio signals. A beamformer (e.g., BF 201) may receive the individually processed first and second digital audio signals.

The BF 201 may isolate the first and second audio signals associated with a target direction based on the target sound, wherein the BF 201 may apply weights to one or more directional inputs associated with the first and second digital audio signals. The weights may favor the target direction thus eliminating (e.g., cancelling or reducing) digital audio data not associated with the target direction. As such, the portions of the first and second digital audio data that may have been associated with crowd noise may have been eliminated. The BF 201 may combine the first and second digital audio signal, where the remaining digital audio signal may be associated with the talker (e.g., the target) to create a beamformer digital audio signal. The beamformer audio signal may then undergo feedforward processing (e.g., feedforward processing 205) to create a target audio signal associated with the target (e.g., talker or sound source).

The target audio signal may be split into two target audio signals that comprise the same audio content. The two target audio signals may be received by a phase shifter (e.g., phase shifter 210), where one of the two target audio signals may be phase shifted. For example, one of the two target audio signals may be inverted (e.g., shifted 180 degrees). The phase shift may further reduce any noise associated with the target audio signal. The phase shifted target audio signals may then be transmitted to a loudspeaker (e.g., loudspeaker 220) so that the user may hear the audio associated with the target (e.g., talker).

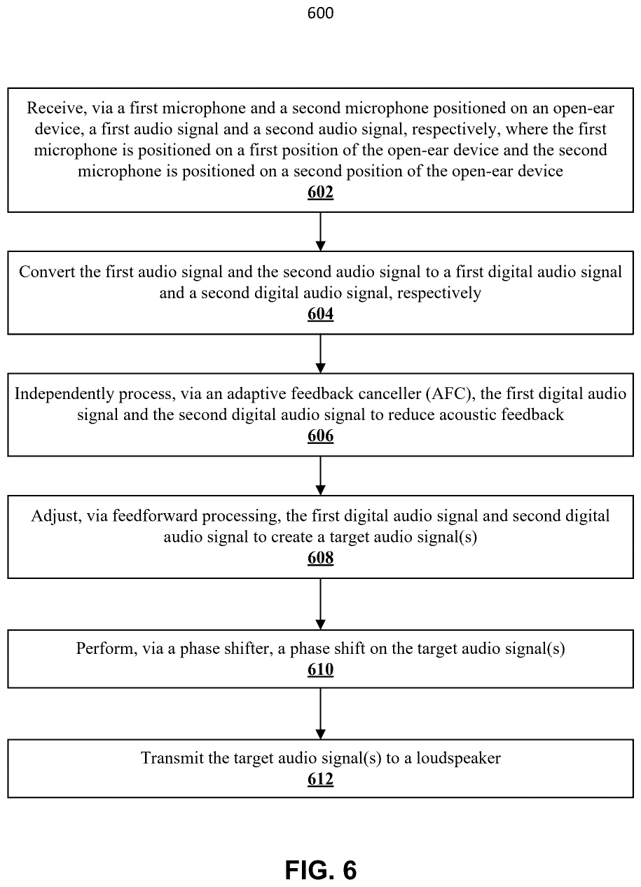

FIG. 6 illustrates an example method 600 according to another aspect of the subject technology. The method 600 may comprise a computer implemented method for mitigating acoustic feedback. A system and/or computing environment, such as, for example, the HMD 100 of FIG. 1, open ear device 120 of FIG. 2A, open ear device 120 of FIG. 3A, and/or the computing environment of FIG. 7, may be configured to perform the method 600. The method 600 may be performed in connection with the HMD 100 illustrated in FIG. 1, the open ear device 120 illustrated in FIG. 2A, or open ear device 120 FIG. 3A. Any step or combination of steps of the method 600 may be performed by a user device (e.g., HMD 100 or open ear device 120), a server, a processor (e.g., processor 32), or any combination thereof.

At step 602, a first audio signal and a second audio signal may be received. The first audio signal, the second audio signal, and the third audio signal may be received via a first microphone (e.g., first microphone 111) and a second microphone (e.g., second microphone 112) microphone, respectively. The first microphone 111 and the second microphone 112 may be positioned on the open ear device 120. The first microphone 111 may be positioned at a first position associated with the open ear device 120, and the second microphone 112 may be positioned at a second position associated with the open ear device 120. In an example, the first position may be on a first side of the open ear device 120 (e.g., a left side), and the second position may be on a second side of the open ear device 120 (e.g., a right side). In some examples, the first side (e.g., the left side) and the second side (e.g., the right side) may be attached via a third side of the open ear device 120. It is contemplated that the first position and the second position may be positioned on any suitable portion or side associated with open ear device 120. It is further contemplated that the first microphone 111 and second microphone 112 need not be positioned on opposing sides of the open ear device 120. In some alternative examples, the first position and the second position may be determined based on a distance from a loudspeaker (e.g., loudspeaker 220). In an example, the loudspeaker 220 may be positioned on the open ear device 120.

At step 604, the first audio signal and the second audio signal may be converted to a first digital audio signal and a second digital audio signal, respectively. In some examples, an ADC convert may be utilized to convert the first audio signal to the first digital audio signal, and the second audio signal to the second digital audio signal.

At step 606, the first digital audio signal and the second digital audio signal may be independently processed, via an adaptive feedback canceller (AFC) (e.g., AFC 215). For example, the first digital audio signal associated with the first microphone may be associated with a first AFC, and the second digital audio signal associated with the second microphone 112 may be associated with a second AFC. In an example, AFC 215 may be one or more of an application, algorithm, process, or method utilized for canceling (e.g., mitigating) acoustic feedback associated with a device (e.g., open ear device 120). A coustic feedback may be a positive feedback response that may occur when an audio path between an audio input (e.g., a first microphone 111 or a second microphone 112) and an audio output (e.g., a loudspeaker 220) creates an acoustic loop. The positive feedback response may refer to a process in a feedback loop (e.g., acoustic loop) which may exacerbate the effects of small captured audio signals. For example, an audio signal may be received by a first microphone 111, the audio signal is amplified and passed out of a loudspeaker 220, the sound from the loudspeaker 220 may then be received by the microphone again. As such, the audio signal associated with the sound from the loudspeaker 220 may be amplified, and then outputted through the speaker again. The action of the sound from the speaker being captured again through the microphone may result in a howl or distortion of the output associated with the loudspeaker 220. In some examples, AFC 215 may be utilized to mitigate the resultant howl or distortion to mitigate acoustic feedback, where the howl or distortion may be any unwanted sound.

In an example, AFC 215 may estimate a first transfer function associated with the first digital audio signal and a second transfer function associated with the second digital audio signal. The transfer functions (e.g., the first transfer function and the second transfer function) may be a representation (e.g., mathematical representation) of a comparison of two audio signals (e.g., the first audio signal and an audio signal (e.g., resultant howl) associated with the loudspeaker 220, or the second audio signal and an audio signal associated with the loudspeaker 220) to verify one or more of a proper gain, phase, frequency response, or the like, or any combination thereof, through the open ear device 120. In some examples, the transfer functions may be a representation (e.g., mathematical representation) that may define the form of an audio signal associated with an acoustic pathway that the sound of a pulse physically goes through to arrive at a destination (e.g., a microphone) from a particular source location (e.g., a loudspeaker).

In an example, the AFC 215 may filter and adjust the first digital audio signal and the second digital audio signal via an adaptive filter, based on the transfer functions (e.g., the first transfer function and the second transfer function) determined and the difference between the first digital audio signal and the second digital audio signal associated with the first microphone and the second microphone, respectively. AFC 215 may filter and adjust the digital audio signals (e.g., the first digital audio signal and second digital audio signal) to isolate the digital audio signals from acoustic feedback to a resultant digital audio signal, where the resultant digital audio signal may be the digital audio signals (e.g., the first digital audio signal and the second digital audio signal) associated with the first microphone 111 and the second microphone 112 without acoustic feedback. For example, the processes associated with AFC 215 may result in (e.g., or output) the first digital audio signal with mitigated acoustic feedback (e.g., a first resultant signal) and the second digital audio signal with mitigated acoustic feedback (e.g., a second resultant signal). The first AFC signal may be the first digital audio signal with less noise (e.g., some degree of potential acoustic feedback canceled), and the second AFC may be the second digital audio signal with less noise (e.g., some degree of potential acoustic feedback canceled). In some examples, the difference between the first digital audio signal and the second digital audio signal may be programmed, known, and/or stored to the system, via a database.

At step 608, the first digital audio signal and the second digital audio signal independently processed, by the AFC 215 of step 606 may be adjusted (e.g., processed) via feedforward processing (e.g., feedforward processing 205) to create a target digital audio signal(s) (e.g., a first target digital audio signal and a second target digital audio signal). In an example, feedforward processing 205 may be any audio pathway that leads to the playing/output of sound (e.g., playing/output of the target audio), via a loudspeaker 220, in which the loudspeaker 220 may be positioned on the open ear device 120. Feedforward processing 205 may include, but is not limited to, amplifying, encoding, decoding, noise reduction, equalization, dynamic range compression, or the like, or any combination thereof. It is contemplated that, in some examples, feedforward processing 205 may include a DAC such that the target digital audio signal(s) that has been processed may be converted to a target audio signal(s).

At step 610, a phase shift of the target audio signal(s), may be performed, via a phase shifter (e.g., phase shifter 211). The target audio signal(s) may comprise a first target audio signal and a second target audio signal processed via feedforward processing 205, wherein the first target audio and the second target audio are associated with the first digital audio signal and the second digital audio signal, respectively, processed via feedforward processing 205 of step 608. In some examples, the phase shifter 211 may be a dynamic phase shifter. In an example, the phase shifter 211 may be configured to shift one or more of the first digital audio signal (e.g., a first target audio signal) and the second digital audio signal (e.g., a second target audio signal). In some other examples, the phase shifter 211 may be configured to shift the first digital audio signal and second digital audio signal by a known dynamic phase shift based on the first position associated with the first microphone 111 and a second position associated with the second microphone 112 on the open ear device 120. For example, the first digital audio signal (e.g., the first target audio signal) associated with the first microphone 111 at the first position may be shifted (e.g., shifted 9 Hz), whereas the second digital audio signal (e.g., the second target audio signal) associated with the second microphone 112 at the second position may be phase shifted (11 Hz) based on the position of the second microphone 112. In some examples, the dynamic phase shift may also be time-varying, such that as time increases the phase associated with the first digital audio signal and the second digital audio signal may be changed by any suitable value as long as the phase of the first digital audio signal does not equal the phase of the second digital audio signal. In such examples, a phase shifter associated with a time-varying phase shift may be configured to continuously vary the phase shift between the first microphone 111 and the second microphone 112. In an example, the dynamic phase shift between the target audio signals from the first microphone 111 and the second microphone 112, the phase shifter may disrupt the conditions that cause acoustic feedback. As such, the dynamic phase shift may prevent the sound waves from aligning in a way that reinforces the feedback loop, thereby reducing or eliminating the unwanted noise.

At step 612, the target audio signal(s) (e.g., the first target audio signal and the second target audio signal) may be transmitted to the loudspeaker 220. In some examples, the loudspeaker 220 may be positioned on the open ear device 120. The target audio signal(s) may be associated with the target direction, wherein the target audio signal(s) may be derived or processed from the first audio signal and second audio signal of step 602 associated with a target (e.g., sound source).

For example, a user wearing an open ear device (e.g., open ear device 120) may be listening to music, via a loudspeaker (e.g., loudspeaker 220) associated with the open ear device 120, in a crowded room. The user may be struggling to hear the music normally due to the noise associated with the crowded room and acoustic feedback associated with the music being played being picked up via one or more microphones associated with the open ear device 120. As such, the user may utilize the open ear device 120 to mitigate the noise associated with acoustic feedback and the crowded room. The open ear device 120 may receive a first and second audio signals associated with a target sound (e.g., the music) and surrounding sounds (e.g., sounds from the crowded room). The first and second audio signals may be converted to a first digital audio signal and a second digital audio signal, respectively. The first and second digital audio signals may be transmitted to a AFC (e.g., AFC 215). AFC 215 may determine transfer functions associated with the first and second digital audio signals. AFC 215 may mitigate (e.g., remove or cancel) the acoustic feedback associated with the first and second digital audio signals.

The individually processed, via AFC 215, first and second digital audio signals may then undergo feedforward processing to create a target audio signal associated with the target (e.g., sound source (e.g., music from loudspeaker 220)). The target audio signal may comprise a first target audio signal associated with the first digital audio signal and a second target audio signal associated with the second digital audio signal. The first target audio signal and the second target audio signal may be received by a dynamic phase shifter (e.g., phase shifter 211), where the first target audio signal and the second target audio signals may be phase shifted based on positioning of the first microphone and the second microphone. The first microphone may be positioned at a first position associated with a first side (e.g., right side) and the second microphone may be positioned at a second position associated with a second side (e.g., left side). The first target audio signal may be phase shifted by a known phase shift based on the first position and the second target audio signal may be phase shifted based on the second position. In an example, the phase shifter 211 may further phase shift the first and second target audio signals, via a dynamic time-varying phase shift, where the phase associated with the first and second digital audio signals may continuously shift with time. It is contemplated that the phase of the first target audio signal and the second target audio signals will not be the same phase.

Lastly, the phase shifted first target audio signal and second target audio signals (e.g., the target audio (e.g., the music)) may be transmitted to a loudspeaker (e.g., loudspeaker 220) so that the user may hear the audio associated with the target (e.g., talker).

It is contemplated that the steps of FIG. 5 or FIG. 6 need not occur iteratively or simultaneously and may occur in any suitable manner that need not be sequential. Further, it is contemplated that the method 500 or method 600 may include additional steps, different steps, or differently arranged steps than those depicted in FIG. 5 or FIG. 6, respectfully.

It is contemplated that the methods and devices as disclosed may mitigate feedback present in an open-ear system (e.g., device 100, device 120). For example, cross feedback may degrade sound quality and is a prevalent issue among many devices. However, the methods and systems described herein may improve cancellation (e.g., mitigation) of cross feedback, thus leading to lower residual feedback and improved sound quality in such systems.

FIG. 7 illustrates a block diagram of an example hardware/software architecture of user equipment (UE) 30. As shown in FIG. 7, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NIM H), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

According to yet another aspect of the subject technology, a method, system, or apparatus is envisaged for receiving, via a first microphone and a second microphone positioned on an open ear device, a first audio signal and a second audio signal, respectively; converting the first audio signal and the second audio signal to a first digital audio signal and a second digital audio signal, respectively; independently processing, via an adaptive feedback canceller (AFC), the first and second digital audio signals to reduce acoustic feedback; adjusting, via a beamformer and based on a target direction, the first and second digital audio signals independently processed by the AFC to create a beamformer digital audio signal; adjusting via feedforward processing, the phase-shifted beamformer digital audio signal to create a target audio signal; performing, via a phase shifter, a phase shift of the target audio signal; and transmitting the target audio signal based on the target direction to a loudspeaker. The beamformer may be a symmetrical mono beamformer configured to define the target direction by applying a specific weight to one or more directional inputs associated with the first digital audio signal and the second digital audio signal, and the specific weights may be utilized to adjust the phase and amplitude of the directional inputs associated with the first digital audio signal and the second digital audio signal associated with the target direction. The AFC may estimate a transfer function based on the acoustic feedback associated with the first digital audio signal and the second digital audio signal. The AFC may employ the transfer function to mitigate the acoustic feedback. The phase shifter may be configured to shift the first digital audio signal and the second digital audio signal by a known phase based on a first position associated with the first microphone and a second position associated with the second microphone on the open ear device. The first position may be on a first side of the open ear device and the second position may be on a second side of the open ear device, with the first side and the second side attached via a third side of the open ear device. The loudspeaker may be positioned on the open ear device.

According to yet another aspect of the subject technology, a method, system, or apparatus is envisaged for receiving, via a first microphone and a second microphone positioned on an open ear device, a first audio signal and a second audio signal, respectively, where the first microphone is positioned on a first position of the open ear device and the second microphone is positioned on a second position of the open ear device; converting the first audio signal and the second audio signal to a first digital audio signal and a second digital audio signal, respectively; independently processing, via an adaptive feedback canceller (AFC), the first digital audio signal and second digital audio signal to reduce acoustic feedback; adjusting, via feedforward processing, the phase-shifted first digital audio signal and second digital audio signal to create a target audio signal; performing, via a phase shifter, a phase shift of the target audio signal; and transmitting the target audio to a loudspeaker. The phase shifter may be configured to shift the first digital audio signal based on the first position and the second digital audio signal based on the second position. The first position may be on a first side of the open ear device and the second position may be on a second side of the open ear device, with the first side and the second side attached via a third side of the open ear device. The loudspeaker may be positioned on the first and/or the second side of the open ear device. The AFC may estimate a transfer function based on acoustic feedback associated with the first digital audio signal and the second digital audio signal. The AFC may employ the transfer function to mitigate acoustic feedback.

According to yet another aspect of the subject technology, a system or apparatus may comprise: a loudspeaker; a first microphone, a second microphone, and a third microphone; a processor and a memory operably coupled to the processor, the memory including executable instructions which when executed by the processor cause the device to: receive, via the first microphone, the second microphone, and the third microphone, a first audio signal, a second audio signal, and a third audio signal, respectively; convert the first audio signal, the second audio signal, and the third audio signal to a first digital audio signal, a second digital audio signal, and a third audio signal, respectively; independently process, the first, second, and third digital audio signals to reduce acoustic feedback; adjust the independently processed first, second, and third digital audio signals to create a target audio signal; and transmit the target audio signal to a loudspeaker. The first microphone may be associated with a first position, the second microphone may be associated with a second position on the device. The first position may be on a first side and/or a second side of the device. The second position may be on the first side and/or the second side of the device. The first side and the second side may be attached via a third side of the device, wherein the third microphone is at a third position on the third side of the device. The loudspeaker may be positioned on the first and/or the second side of the device, where the loudspeaker may be proximal to the first microphone at the first position and distal to the second microphone at the second position.

According to yet another aspect of the subject technology, a system or apparatus may comprise: a loudspeaker; a first microphone, a second microphone, and a third microphone, where the first microphone is positioned a first distance from the loudspeaker, the second microphone is positioned a second distance from the loudspeaker, and the third microphone is positioned a third distance from the loudspeaker; a processor and a memory operably coupled to the processor, the memory including executable instructions which when executed by the processor cause the device to: receive, via the first microphone, the second microphone, and the third microphone, a first audio signal, a second audio signal, and a third audio signal, respectively; convert the first audio signal, second audio signal, and third audio signal to a first digital audio signal, a second digital audio signal, and a third digital audio signal, respectively; independently process the first, second, and third digital audio signals to reduce acoustic feedback; analyze the first digital audio signal to determine a list of characteristics associated with feedback; filter the first digital audio signal, second digital audio signal, and third digital audio signal based on a known difference and the list of characteristics associated with the first digital audio signal; adjust the filtered first, second, and third digital audio signals to create a target audio signal; and transmit the target audio signal to the loudspeaker. The known difference may be known acoustic feedback value based on distance from the loudspeaker. The second digital audio signal and the third digital audio signal may be filtered based on the list of characteristics associated with the first digital audio signal and the known difference. The adaptive feedback canceller may further comprise a feedback mechanism configured to detect acoustic feedback associated with the first digital audio signal, the second digital audio signal, and the third digital audio signal. The first distance may be smaller than the second and third distances, indicating higher acoustic feedback associated with the first digital audio signal compared to the second and third digital audio signals.

According to yet another aspect of the subject technology, a system or apparatus may comprise: a loudspeaker; a first microphone, a second microphone, and a third microphone, where the first microphone is positioned a first distance from the loudspeaker, the second microphone is positioned a second distance from the loudspeaker, and the third microphone is positioned a third distance from the loudspeaker; a processor and a memory operably coupled to the processor, the memory including executable instructions which when executed by the processor cause the device to: receive, via the first microphone, the second microphone, and the third microphone, a first audio signal, a second audio signal, and a third audio signal, respectively; convert the first, second, and third audio signals to a first digital audio signal, a second digital audio signal, and a third digital audio signal, respectively; process independently the first, second, and third digital audio signals to estimate a transfer function associated with the first, second, and third digital audio signals; analyze the first digital audio signal to determine a list of characteristics associated with a first acoustic feedback; filter the first, second, and third digital audio signals based on a difference and the list of characteristics associated with the first digital audio signal; attenuate the first, second, and third digital audio signals based on a target direction. The target direction may be defined by applying specific weights to one or more directional inputs associated with the first, second, and third digital audio signals. The specific weights applied may be utilized to adjust the phase and amplitude of one or more directional inputs associated with the target direction. The transfer function may be estimated to mitigate acoustic feedback associated with the first, second, and third digital audio signals. The first, second, and third microphones may comprise one or more of Micro-Electro-Mechanical Systems (MEMS) microphones, condenser microphones, dynamic microphones, electret microphones, bone conduction transducers, and cartilage conduction transducers.

According to yet another aspect of the subject technology, a method, system, or apparatus may provide for receiving an audio signal via one or more microphones positioned on an open ear device; converting the audio signal to a digital audio signal; transmitting digital audio data to an adaptive feedback canceller; estimating a transfer function via the adaptive feedback canceller, where the transfer functions estimated comprise a coefficient scaled by a value to produce maximum forward gain; filtering, via the transfer functions, the digital audio signal; and applying a beamformer to determine a target audio, where the beamformer adjusts the digital audio signal based on a target direction. The method may further include adjusting, via feedforward processes, the target audio for presentation to a user associated with the open ear device. One of the one or more microphones may be associated with one adaptive feedback canceller.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
receiving, via a first microphone and a second microphone positioned on an open ear device, a first audio signal and a second audio signal, respectively;
converting the first audio signal and the second audio signal to a first digital audio signal and a second digital audio signal, respectively;
independently processing, via an adaptive feedback canceller (AFC), the first and second digital audio signals to reduce acoustic feedback;
adjusting, via a beamformer and based on a target direction, the first and second digital audio signals independently processed by the AFC to create a beamformer digital audio signal;
adjusting via feedforward processing, the beamformer digital audio signal to create a target audio signal(s);
performing, via a phase shifter, a phase shift on the target audio signal(s); and
transmitting the target audio signal(s) along the target direction to a loudspeaker.

2. The method of claim 1, wherein the beamformer is a symmetrical mono beamformer comprising a monaural beamformer or wherein the beamformer comprises a binaural beamformer.

3. The method of claim 2, wherein the symmetrical mono beamformer is configured to define the target direction by applying a specific weight to one or more directional inputs associated with the first digital audio signal and the second digital audio signal, and wherein the specific weights are utilized to adjust phase and amplitude of the one or more directional inputs associated with the first digital audio signal and the second digital audio signal associated with the target direction.

4. The method of claim 1, wherein the AFC estimates a transfer function based on the acoustic feedback associated with the first digital audio signal and the second digital audio signal, and wherein the AFC employs the transfer function to mitigate the acoustic feedback.

5. The method of claim 1, wherein the phase shifter is configured to shift the first digital audio signal and the second digital audio signal by an identified or determined phase based on a first position associated with the first microphone and a second position associated with the second microphone on the open ear device.

6. The method of claim 5, wherein the first position is on a first side of the open ear device and the second position is on a second side of the open ear device.

7. The method of claim 6, wherein the first side and the second side are attached via a third side of the open ear device.

8. The method of claim 6, wherein the loudspeaker is positioned on the first side and/or the second side of the open ear device.

9. A method comprising:
receiving, via a first microphone and a second microphone positioned on an open ear device, a first audio signal and a second audio signal, respectively, where the first microphone is positioned on a first position of the open ear device and the second microphone is positioned on a second position of the open ear device;
converting the first audio signal and the second audio signal to a first digital audio signal and a second digital audio signal, respectively;
independently processing, via an adaptive feedback canceller (AFC), the first and second digital audio signals to reduce acoustic feedback;
adjusting, via feedforward processing, the first digital audio signal and the second digital audio signal to create a target audio signal(s);
performing, via a phase shifter, a phase shift on the target audio signal(s); and
transmitting the target audio signal(s) to a loudspeaker.

10. The method of claim 9, wherein the phase shifter is configured to shift the first digital audio signal based on the first position.

11. The method of claim 9, wherein the phase shifter is configured to shift the second digital audio signal based on the second position.

12. The method of claim 9, wherein the first position is on a first side of the open ear device and the second position is on a second side of the open ear device.

13. The method of claim 12, wherein the first side and the second side are attached via a third side of the open ear device.

14. The method of claim 12, wherein the loudspeaker is positioned on the first side and/or the second side of the open ear device.

15. The method of claim 9, wherein the AFC estimates a transfer function based on acoustic feedback associated with the first digital audio signal and the second digital audio signal, and wherein the AFC employs the transfer function to mitigate acoustic feedback.

16. A device comprising:
a loudspeaker;
a first microphone, a second microphone, and a third microphone;
a processor and a memory operably coupled to the processor, the memory including executable instructions which when executed by the processor cause the device to:
receive, via the first microphone, the second microphone, and the third microphone, a first audio signal, a second audio signal, and a third audio signal, respectively;
convert the first audio signal, the second audio signal, and the third audio signal to a first digital audio signal, a second digital audio signal, and a third digital audio signal, respectively;
independently process, the first digital audio signal, the second digital audio signal, and the third digital audio signal to reduce acoustic feedback;
adjust the independently processed first, second, and third digital audio signals to create a target audio signal; and
transmit the target audio signal to the loudspeaker.

17. The device of claim 16, wherein the first microphone is at a first position and the second microphone is at a second position on the device, and wherein the first position is on a first side and/or a second side of the device and the second position is on the first side and/or the second side of the device.

18. The device of claim 17, wherein the first side and the second side are attached via a third side of the device, and wherein the third microphone is at a third position on the third side of the device.

19. The device of claim 17, wherein the loudspeaker is positioned on the first side and/or the second side of the device.

20. The device of claim 19, wherein the loudspeaker is proximal to the first microphone at the first position and distal to the second microphone at the second position.
